(19) United States
(12) Patent Application Publication
(10) Pub. No.: US 2009/0147047 A1
(43) Pub. Date: Jun. 11, 2009

(54) Printer

(75) Inventor: Yoshihiro Hayashi, Ibaraki-ken (JP)

Correspondence Address: THE NATH LAW GROUP, 112 South West Street, Alexandria, VA, 22314, US

(73) Assignee: RISO KAGAKU CORPORATION, Tokyo (JP)

(21) Appl. No.: 12/292,920

(22) Filed: Dec. 1, 2008

(30) Foreign Application Priority Data
Dec. 5, 2007 (JP) P2007-314703

(51) Int. Cl. B41J 2/165

(52) U.S. Cl. 347/36

(57) ABSTRACT

A printer includes: a printing unit configured to transfer ink to a printing medium; a main tank configured to store unused ink; a sub tank including a bottom surface located lower than a bottom surface of the main tank and configured to receive supply of the unused ink from the main tank; an ink supply unit configured to supply ink stored in the sub tank to the printing unit; and an ink collection unit configured to collect excess ink of the ink supplied to the printing unit by the ink supply unit and to return the excess ink to the sub tank, the excess ink being ink remaining in the printing unit without being transferred to the printing medium.

### CROSS REFERENCE TO RELATED APPLICATION

This application is based upon and claims the benefit of priority from the prior Japanese Patent Application No. 2007-314703, filed on Dec. 5, 2007, the entire contents of which are incorporated herein by reference.

### BACKGROUND OF THE INVENTION

1. Field of the Invention

The present invention relates to a printer used by circulating ink.

2. Description of the Related Art

A stencil printing method has good operability and simplicity, compared with other printing methods such as offset printing, gravure printing, and flexographic printing. For example, the stencil printing method requires neither troublesome work after use such as cleaning nor a skilled operator. The advent of the heat-sensitive stencil making system using a thermal print head as a device has lead to the digitization of image processing in the stencil printing method, so that high quality printed sheets can easily be obtained in a short time. Then, the stencil printing system in which image processing is digitized has been recognized as an information processing terminal from the viewpoint of the convenience. Furthermore, the stencil printing method with image processing thus digitized has been increasingly recognized as convenient also for use in an information processing terminal.

Nowadays, rotary stencil printing machines are capable of performing printing by automatically controlling operations of making, loading and disposing stencil sheets, an ink supply operation, a printing operation and the like, and such rotary stencil printing machines are widely used under the name of a digital stencil printing machine (stencil printer) in offices, schools, etc.

An inner press method described in Japanese Unexamined Patent Application Publication No. Hei 7-132675 and an outer press method described in Japanese Patent Application Publication No. 2001-246828 have been known as related printing methods of the stencil printing machine.

In such stencil printing machines, an ink pool is formed in a space between outer circumferences of a doctor roller and an inner pressure roller or a squeegee roller. In order to maintain the ink in the ink pool at an approximately constant volume, an ink volume detection sensor is provided to the ink pool. When the ink volume is less than a certain volume, the ink pool is refilled with ink from an ink tank by using a drive unit such as a pump or the like.

Moreover, Japanese Patent Application Publications Nos. 2004-122712 and 2005-53209 have proposed a stencil printing machine including a rotatable drum. In a stencil printing machine of this type, ink collected from the drum has ink characteristics different from those of unused ink (new ink) For this reason, when an ink tank is running out of ink and therefore is refilled with new ink, printing is executed by using almost only the collected ink immediately before the ink refilling, and then by using almost only the new ink immediately after the ink refilling. Accordingly, there arises a problem that the printing state of a printed sheet greatly differs between before and after the ink refilling.

In this regard, Japanese Patent Application Publication No. 2005-297193 has proposed a stencil printing machine that is capable of producing a printed sheet in an approximately uniform state by preventing the print state of the printed sheet from changing largely before and after the ink refilling. In this stencil printing machine, an ink tank includes a main tank which stores new ink, and a sub tank which stores collected ink, and is configured to preferentially supply the ink from the sub tank to a printing section.

On the other hand, the inkjet method is a plateless printing method and has a characteristic that the inkjet method can perform variable printing which is impossible in a plate printing system such as a stencil printing system. For this reason, this method has rapidly come into wide use in the market in recent years.

The printing method of the inkjet printer includes a drop-on-demand method and a continuous method (continuous ejection method). Since the inkjet printer using the continuous ejection method has characteristics that, for example, printing can be performed with a relatively large distance between a nozzle plate and a printing medium, the inkjet printer is widely used for high speed printing onto continuous sheets, printing onto a curved surface (a can or the like), printing onto corrugated paper, and the like.

The inkjet printer of the continuous ejection type always ejects ink in a continuous manner and provides every ink droplet with a signal indicating a printing area or non-printing area. The inkjet printer applies an electrical charge to either the ink droplet for the printing area (ink droplet that is to be transferred onto the printing medium) or the ink droplet for the non-printing area (ink droplet that is not to be transferred onto the printing medium) to deflect flight of the ink droplet, whereby the ink droplets are separated into one that flies to a printing medium and one that flies to a collection machine with a suction device. The ink droplets flown to the collection machine are collected into the ink tank and disposed or reused.

Even in the inkjet printer of this type, the collected ink has the ink characteristics different from those of unused ink. Accordingly, as described in Japanese Unexamined Patent Application Publication No. Hei 2-196663, when ink is circulated to be reused, it is necessary to control the volume of used ink (ejection volume) and the characteristics of circulating ink. More specifically, the ink needs to be controlled so that the ink droplets can keep a normal charging capability and thereby can normally fly, by refilling the ink tank with new ink or ink characteristic adjusting liquid, as appropriate, by use of a drive device such as a pump.

Meanwhile, in the stencil printing machine proposed in Japanese Patent Application Publication No. 2005-297193, printing is executed with mixed ink of collected ink and new ink just before the ink refilling for the main tank, while executed almost purely with new ink just after the ink refilling. Namely, the ink volume in the sub tank varies in proportion to the ink volume in the main tank, and therefore, when the main tank is running out of ink and is refilled with ink, a large volume of new ink flows into the sub tank at one time. For this reason, the print state of the printed sheet still differs between before and after the ink refilling, although the print state does not greatly differ.

Hence, in order to almost perfectly prevent the change in the print state of the printed sheet between before and after the ink refilling, it is necessary to prevent a large volume of new ink from flowing into the sub tank at one time. For this purpose, the main tank must be refilled with ink before the volume of the ink remaining in the main tank becomes low, namely, when a sufficient volume of ink still remains in the main tank. This causes a problem that frequent ink refilling is needed.

Additionally, in the inkjet printer proposed in Japanese Unexamined Patent Application Publication No. Hei 2-196663, collected ink is returned into the main tank and then is circulated. For this reason, accurate detection and measurement must be performed in order to maintain a circulating ink volume and ink density constant. This causes a problem that the inkjet printer needs to be equipped with accurate and complicated devices such as a detector for transmitted light quantity or the like, a measuring device for ink consumption volume (ink ejection volume), a device for supplying new ink, an ink supply position adjustment device and an ink stirrer.

### SUMMARY OF THE INVENTION

The present invention has been made in view of the aforementioned circumstances, and an object of the present invention is to provide a printer that prevents an occurrence of a change in a print state of a printed sheet between before and after ink refilling and that does not require frequent ink refilling and complicated devices.

To achieve the above object, a first aspect of the present invention is a printer comprising: a printing unit configured to transfer ink to a printing medium; a main tank configured to store unused ink; a sub tank having a bottom surface located lower than a bottom surface of the main tank and configured to receive supply of the unused ink from the main tank; an ink supply unit configured to supply ink stored in the sub tank to the printing unit; and an ink collection unit configured to collect excess ink from the ink supplied to the printing unit by the ink supply unit and to return the excess ink to the sub tank, the excess ink being ink remaining in the printing unit without being transferred to the printing medium by the printing unit.

According to the first aspect of the present invention, the bottom surface of the sub tank is located lower than that of the main tank. Hence, even if the ink (unused ink) of the main tank runs out, the mixed ink is left in the sub tank. Therefore, even if the main tank is refilled with the unused ink after the volume of ink remaining in the main tank is low or the ink completely runs out, printing after the refilling is performed by use of mainly the mixed ink left in the sub tank. Accordingly, even if the main tank is not frequently refilled with the unused ink, it is possible, with a simple configuration, to prevent an occurrence of a change in the print state of the printed sheet between before and after refilling the main tank with the unused ink, and thereby to make print quality uniform easily.

The sub tank may include an upper side portion and a lower side portion, and a cross-sectional area of the upper side portion taken along a horizontal plane may be smaller than a cross-sectional area of the lower side portion taken along a horizontal plane.

According to the above configuration, the cross-sectional area of the upper side portion is smaller than that of the lower side portion. Therefore, even if the main tank is refilled with the unused ink after the volume of ink remaining in the main tank is low or the ink runs out, the volume of new ink flowing into the sub tank can be suppressed. Hence, it is possible to further suppress an occurrence of a change in the print state of the printed sheet between before and after refilling the main tank with the ink.

The sub tank may be divided into a plurality of portions at a place where the excess ink is returned to the sub tank by the ink collection unit, and the sub tank may be configured to use one of the divided portions to receive the excess ink returned by the ink collection unit.

According to the above configuration, the ink collection unit is configured to return the ink to one of the multiple divided portions. Therefore, even if the ink is dropped on the one portion and fine bubbles are generated in the ink to move the bubbles to the lower portion of the sub tank, the moved bubbles float from any other portion of the divided multiple portions and easily escape to the space of the upper portion in the sub tank. Thereby, it is possible to suppress residence of the bubbles in the sub tank and achieve stable printing.

The sub tank may include an upper sub tank and a lower sub tank connected to each other through a throttle, the upper sub tank may be configured to receive the ink supplied from the main tank, the ink collection unit may be configured to return the excess ink to the upper sub tank, and the ink supply unit may be configured to supply the ink stored in the lower sub tank to the printing unit.

According to the above configuration, the upper sub tank and the lower sub tank are connected to each other through the throttle. Therefore, the collected ink and new ink are surely mixed with each other, so that more stable printed sheets can be obtained. Namely, the new ink refilled from the main tank can be prevented from being supplied to the printing unit before being well mixed with the collected ink.

A cross-sectional area of the upper sub tank taken along a horizontal plane may be smaller than a cross-sectional area of the lower sub tank taken along a horizontal plane.

According to the above configuration, the cross-sectional area of the lower sub tank taken along a horizontal plane is larger than that of the upper sub tank taken along a horizontal plane. Therefore, even if the main tank is refilled with the unused ink after the volume of ink remaining in the main tank is low or the ink runs out, it is possible to suppress the volume of new ink flowing into the sub tank. Hence, it is possible to further suppress an occurrence of a change in the print state of the printed sheet between before and after refilling the main tank with the ink.

The upper sub tank may be divided into a plurality of portions at a place where the excess ink is returned to the upper sub tank by the ink collection unit, and the upper sub tank may be configured to use one of the divided portions to receive the excess ink returned by the ink collection unit.

According to the above configuration, the ink collection unit is configured to return the ink to one of the multiple divided portions. Therefore, even if the ink is dropped on one portion and fine bubbles are generated in the ink to move the bubbles to the lower portion of the sub tank, the moved bubbles float from any other portion of the divided multiple portions and easily escape to the space of the upper portion in the sub tank. This exhibits effects that residence of bubbles in the sub tank can be suppressed and stable printing can be achieved.

The printer may further comprise a collected ink receiver configured to receive excess ink returned from the printing unit by the ink collection unit. And the sub tank may be configured to receive the excess ink from the collected ink receiver through an ink passage.

According to the above configuration, the collected ink receiver is provided, thus making it possible to prevent ink containing fine bubbles from being supplied to the sub tank without fail.

The printing unit may include an inkjet head.

According to the above configuration, the bottom surface of the sub tank is located lower than that of the main tank. Therefore, even when the printing head includes an inkjet head, the main tank need not be frequently refilled with the unused ink. In addition, this exhibits effects that, with a simple configuration, an occurrence of a change in the print state of the printed sheet between before and after refilling the main tank with the unused ink can be suppressed, and therefore the print quality is easily made uniform.

To achieve the above object, a second aspect of the present invention is a printer comprising: a printing unit configured to transfer ink to a printing medium; a main tank configured to store unused ink; a sub tank having a bottom surface located lower than a bottom surface of the main tank; a first ink supply passage connected to the sub tank; an ink supply unit configured to supply ink stored in the sub tank to the printing unit through the first ink supply passage; an ink collection unit configured to collect excess ink from the ink supplied to the printing unit by the ink supply unit and to return the excess ink to the sub tank, the excess ink being ink remaining in the printing unit without being transferred to the printing medium by the printing unit; and a second ink supply passage configured to supply the unused ink to the first ink supply passage from the main tank.

According to the second aspect, the bottom surface of the sub tank is located lower than that of the maintank. Therefore, similar to the first aspect, it is possible, with a simple configuration, to suppress an occurrence of a change in the print state of the printed sheet between before and after refilling the main tank with the unused ink, even if the main tank is not frequently refilled with the unused ink. Furthermore, the print quality can be easily made uniform.

Similar to the first aspect, the second aspect can employ the aforementioned various configurations and exhibits the same effect as the first aspect.

To achieve the above object, a third aspect of the present invention is a stencil printing machine comprising: a rotatable drum including an outer peripheral wall being formed from an ink impermeable member, the outer peripheral wall having a surface for attachment of a stencil sheet; an ink tank configured to store ink; an ink supply unit including an ink supply section in the outer peripheral wall and configured to supply the ink guided from the ink tank to the surface of the outer peripheral wall by use of the ink supply section; an ink collection unit including an ink collection section in the outer peripheral wall and configured to collect and return excess ink on the surface of the outer peripheral wall to the ink tank by use of the ink collection section; and a pressure roller configured to press a fed printing medium onto the outer peripheral wall, wherein the ink tank includes a main tank storing unused ink, and a sub tank storing both the excess ink collected by the ink collection unit and the unused ink stored in the main tank, the ink supply unit is configured to supply the ink in the sub tank before the unused ink in the main tank, and a bottom surface of the sub tank is located lower than a bottom surface of the main tank.

According to the third aspect, the bottom surface of the sub tank is located lower than that of the main tank. Therefore, similar to the first aspect, it is possible, with a simple configuration, to suppress an occurrence of a change in the print state of the printed sheet between before and after refilling the main tank with the unused ink, even if the main tank is not frequently refilled with the unused ink. Furthermore, the print quality can be easily made uniform.

To achieve the above object, a fourth aspect of the present invention is a stencil printing machine comprising: a drum rotatably supported by a supporting member and including an outer peripheral wall being formed from an ink impermeable member, and the outer peripheral wall having a surface for attachment of a stencil sheet; an ink tank configuration member provided integrally with the supporting member inside the drum; a main tank having a space formed in an internal space of the ink tank configuration member, the space surrounded by a partition wall, a bottom configuration member and the ink tank configuration member, the partition wall dividing an internal space of the ink tank configuration member into parts, the bottom configuration member being provided integrally with the ink tank configuration member and the partition wall, a first end of the bottom configuration member at a side of the partition wall being disposed below the supporting member in a first one of the parts of the internal space divided by the partition wall and being located lower than a second end of the bottom configuration member at an opposite side of the first end; a sub tank having an annular space surrounded by the partition wall, the ink tank configuration member, and an inner side member, the inner side member being provided in a second part of the internal space of the ink tank configuration member divided by the partition wall, being disposed at a middle position in a height direction of the second part, and including an upper inclined surface on an upper side of the inner side member and a lower inclined surface on a lower side of the inner side member, wherein the partition has a lower through hole formed at approximately the same height as a bottom surface of the main tank and connecting the space of the main tank and the space of the sub tank by penetrating the partition wall, and an upper through hole formed in an upper side of both the sub tank and the main tank and connecting the space of the main tank and the space of the sub tank by penetrating the partition wall; an ink supply unit including an ink supply section in the outer peripheral wall and configured to supply ink guided from a lower end of the sub tank to the surface of the outer peripheral wall by use of the ink supply section; an ink collection unit including an ink collection section in the outer peripheral wall and configured to collect excess ink on the surface of the outer peripheral wall by use of the ink collection section, to drop the collected ink onto an upper inclined surface and thereby to return the collected ink to the sub tank; and a pressure roller configured to press a fed printing medium onto the outer peripheral.

According to the fourth aspect, the excess ink is dropped on the upper inclined surface and returned to the sub tank. Therefore, it is possible to reduce an impact force occurring when the collected ink is dropped and thereby to avoid possibility that fine bubbles are generated in the mixed ink in the sub tank, as much as possible.

### BRIEF DESCRIPTION OF THE DRAWINGS

FIG. 1 is a view illustrating a schematic configuration of a stencil printing machine according to a first embodiment of the present invention.

FIG. 2 is a perspective view illustrating a schematic configuration of a drum in FIG. 1.

FIG. 3 is a cross-sectional view taken along the line III-III in FIG. 2.

FIG. 4 is a cross-sectional view taken along the line IV-IV in FIG. 3.

FIG. 5 is a cross-sectional view taken along the line V-V in FIG. 3.

FIG. 6 is a cross-sectional view taken along the line VI-VI in FIG. 3.

FIG. 7 is an enlarged view of a VII part in FIG. 4.

FIG. 8 is a partial cross-sectional view explaining an ink diffusion mechanism.

FIG. 9 is a view illustrating a schematic configuration of an ink tank or the like used in a stencil printing machine according to a second embodiment of the present invention, and corresponds to FIG. 3.

FIG. 10 is a view illustrating a cross section taken along the line X-X in FIG. 9.

FIG. 11 is a view illustrating a schematic configuration of an ink tank or the like.

FIG. 12 is a view illustrating a schematic configuration of an ink tank or the like.

FIG. 13 is a view illustrating a schematic configuration of an ink tank or the like.

FIG. 14 is a view illustrating a schematic configuration of an ink tank or the like.

FIG. 15 is a view illustrating a schematic configuration of an ink tank or the like.

FIG. 16 is a view illustrating a schematic configuration of an ink tank or the like.

FIG. 17 is a view illustrating a schematic configuration of an ink tank or the like used in a stencil printing machine according to a third embodiment of the present invention, and corresponds to, for example, FIG. 11.

FIG. 18 is a view illustrating a schematic configuration of a printer using an inkjet head.

FIG. 19 is a view illustrating a schematic configuration of a printer using an inkjet head.

FIG. 20 is a view illustrating a schematic configuration of a printer using an inkjet head.

### DETAILED DESCRIPTION OF THE EMBODIMENTS

The following will explain embodiments of the present invention based on the drawings. The same or similar reference numerals are applied to the same or similar parts throughout the drawings. The printing machine used by circulating ink includes, for example, a digital rotary stencil printing machine, a continuous type inkjet printer, or the like. The printing machines used by circulating ink are not limited to these.

### First Embodiment

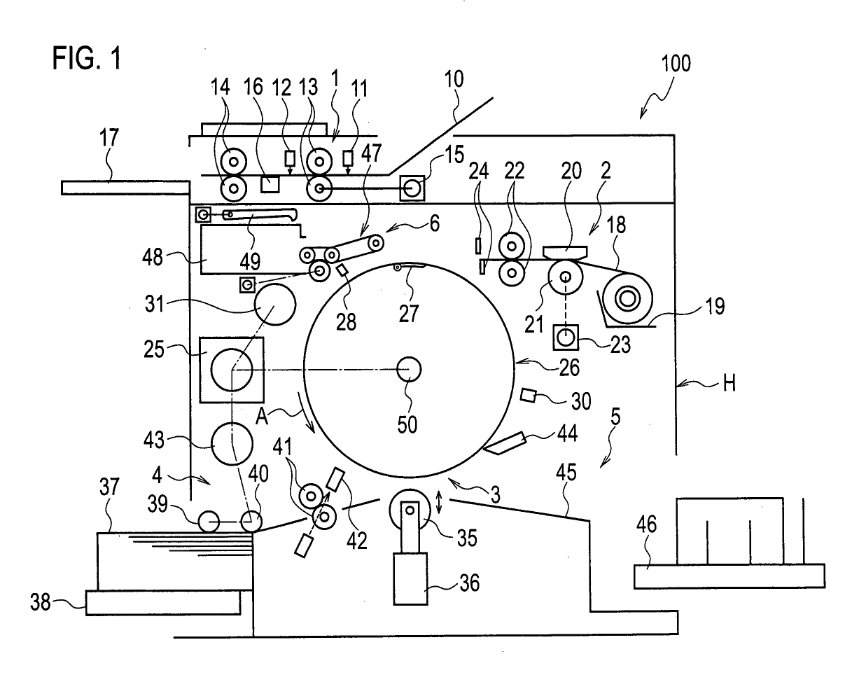

FIG. 1 is a view illustrating a schematic configuration of a stencil printing machine 100 according to a first embodiment of the present invention;

The stencil printing machine 100 mainly includes an original reading unit 1, a stencil making unit 2, a printing unit 3, a paper feed unit 4, a paper delivery unit 5 and a stencil disposal unit 6.

The original scanning unit 1 has an original setting tray 10 on which originals to be printed are stacked, reflective-type original sensors 11 and 12 which detect the presence or absence of the originals on the original setting tray 10, original conveyer rollers 13 and 14 which convey the originals on the original setting tray 10, a stepping motor 15 which rotationally drives the original conveyer rollers 13 and 14, a contact image sensor 16 which optically reads out image data of the originals conveyed by the original conveyer rollers 13 and 14 and converts the data into electrical signals, and an original discharging tray 17 on which the originals discharged from the original setting tray 10 are stacked. The originals stacked on the original setting tray 10 are conveyed by the original conveyer rollers 13 and 14, and the image sensor 16 reads out the image data of the conveyed originals.

The stencil making unit 2 has a stencil sheet housing 19 which houses a long and rolled stencil sheet 18, a thermal print head 20 placed downstream of the stencil sheet housing 19 in a conveying direction, a platen roller 21 placed at a position facing the thermal print head 20, a pair of stencil sheet transfer rollers 22 and 22 placed downstream of the platen roller 21 and the thermal print head 20 in the conveying direction, a write pulse motor 23 which rotationally drives the platen roller 21 and the stencil sheet transfer rollers 22, and a stencil sheet cutter 24 placed downstream of the pair of stencil sheet transfer rollers 22 and 22 in the conveying direction.

Then, the long stencil sheet 18 is conveyed by the rotation of the platen roller 21 and the stencil sheet transfer rollers 22. Based on the image data read out by the image sensor 16, dot-shaped heating elements of the thermal print head 20 selectively perform heating operations, whereby the stencil sheet 18 is perforated due to thermal sensitivity thereof to make a stencil. Then, the stencil sheet 18 thus made is cut by the stencil sheet cutter 24 to make the stencil sheet 18 having a predetermined length.

The printing unit 3 has a drum 26 which rotates in a direction of an arrow A in FIG. 1 by a driving force of a main motor 25, a stencil sheet clamping section 27 which is provided in an outer peripheral surface of the drum 26 and clamps a leading edge of the stencil sheet 18, a stencil sheet confirming sensor 28 which detects whether or not the stencil sheet 18 is wound and attached around the outer peripheral surface of the drum 26, a reference position detecting sensor 30 which detects a reference position of the drum 26, and a rotary encoder 31 which detects the rotation of the main motor 25. Based on detection output of the reference position detecting sensor 30, an output pulse by the rotary encoder 31 is detected, thus the rotation position of the drum 26 can be detected with this configuration.

The printing unit 3 has a pressure roller 35 disposed below the drum 26. The pressure roller 35 is configured to be movable between a press position where the pressure roller 35 presses the outer peripheral surface of the drum 26 by a driving force of a solenoid device 36 and a standby position where the pressure roller 35 is separated apart from the outer peripheral surface of the drum 26. The pressure roller 35 is always positioned at the press position during a printing mode period (including trial print) and positioned at the standby position during a period other than the printing mode.

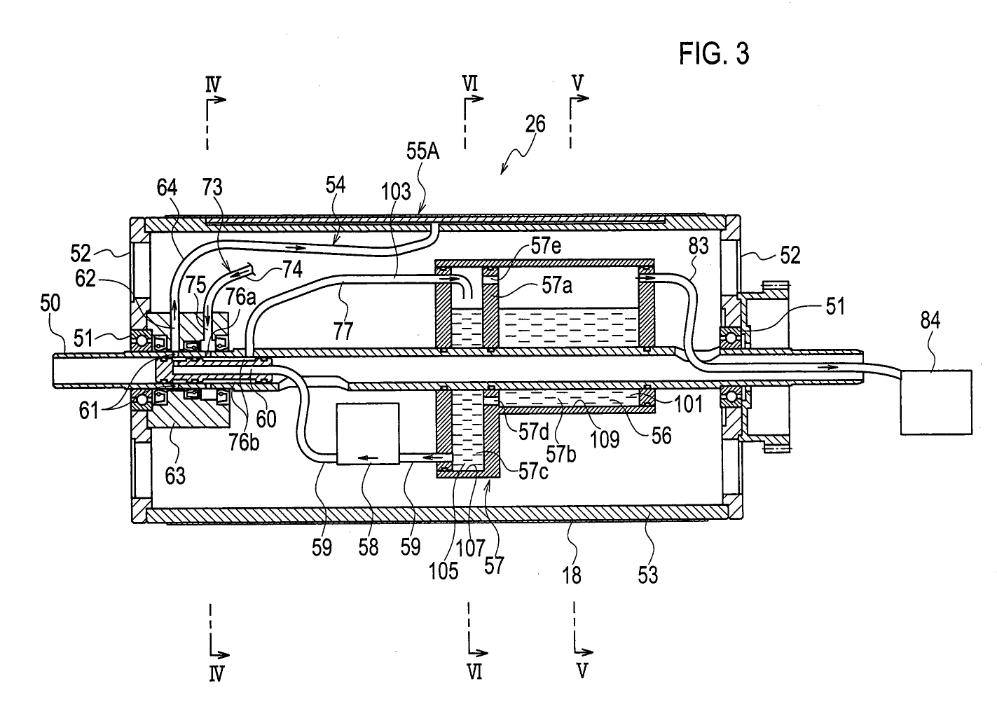

Thereafter, the leading edge of the stencil sheet 18 conveyed from the stencil making unit 2 is clamped by the stencil sheet clamping section 27. The drum 26 is rotated in such a clamping state, so that the stencil sheet 18 is wound around the outer peripheral surface of the drum 26. Then, print sheet (print medium) 37 which is fed by the paper feed unit 4 in synchronization with the rotation of the drum 26, is pressed onto the stencil sheet 18 wound around the outer peripheral surface of the drum 26 by the pressure roller 35. As a result, ink 56 (see FIG. 3) is transferred through perforations of the stencil sheet 18 onto the print sheet 37, and an image is printed.

The paper feed unit 4 has a paper feed tray 38 on which the print sheets 37 are stacked, first paper feed rollers 39 and 40 which convey the print sheet 37 only at the uppermost position from this paper feed tray 38, a pair of second paper feed rollers 41 and 41 which convey the print sheet 37 conveyed by the first paper feed rollers 39 and 40 to a part between the drum 26 and the pressure roller 35 in synchronization with the rotation of the drum 26, and a paper feed sensor 42 which senses whether or not the print sheet 37 is conveyed to a part between the pair of second paper feed rollers 41 and 41. The first paper feed rollers 39 and 40 are configured so that the rotation of the main motor 25 is selectively transmitted thereto through a paper feed clutch 43.

The paper delivery unit 5 has a sheet separator claw 44 which separates the printed print sheet 37 from the drum 26, a conveying passage 45 through which the print sheet 37 removed from the drum 26 by the sheet separator claw 44 is conveyed, and a paper receiving tray 46 on which the print sheet 37 discharged from the conveying passage 45 is stacked.

The stencil disposal unit 6 has a disposed stencil conveying unit 47 which guides the leading edge of the stencil sheet 18 unclamped and released from the outer peripheral surface of the drum 26 and conveys the used stencil sheet 18 thus guided while peeling it off from the drum 26, a stencil disposal box 48 which houses the stencil sheet 18 conveyed by the disposed stencil conveying unit 47, and a disposed stencil compression member 49 which pushes the stencil sheet 18 thus conveyed by the disposed stencil conveying unit 47 into the stencil disposal box 48, into the bottom of the stencil disposal box 48.

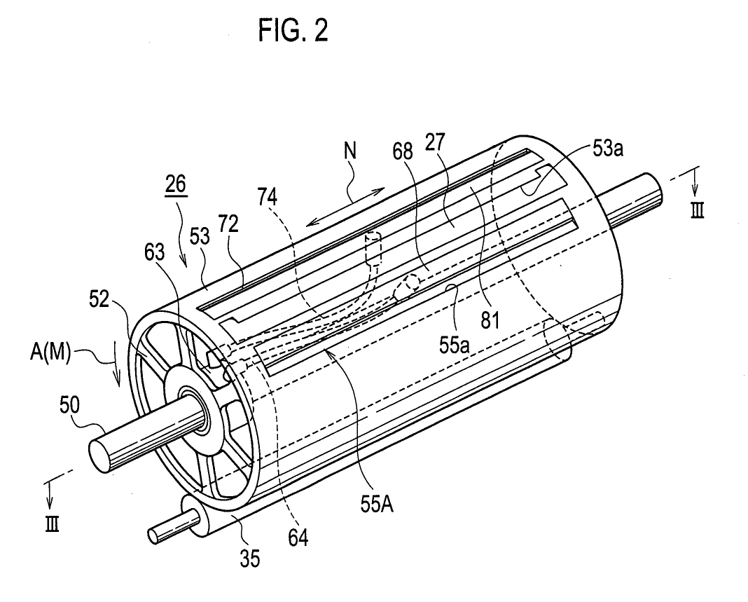

Herein, an explanation of the drum 26 or the like will be specifically explained with reference to FIGS. 2 to 7.

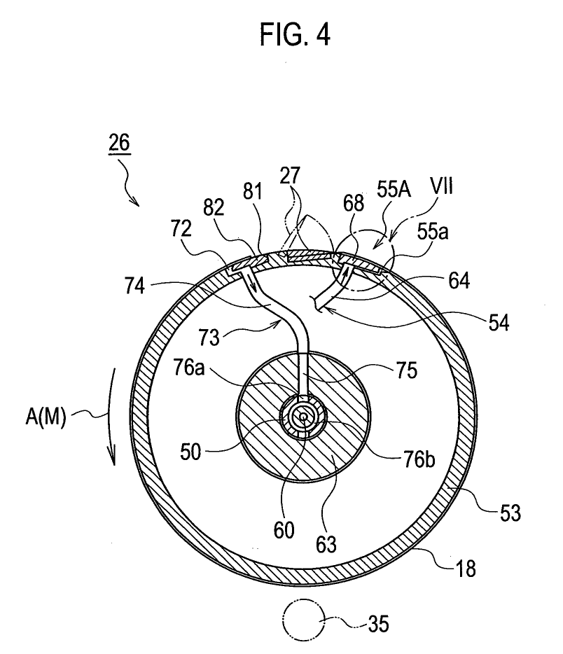

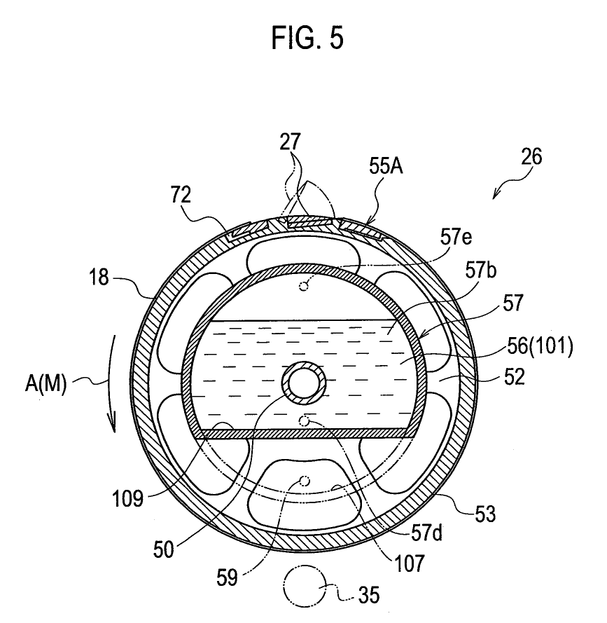

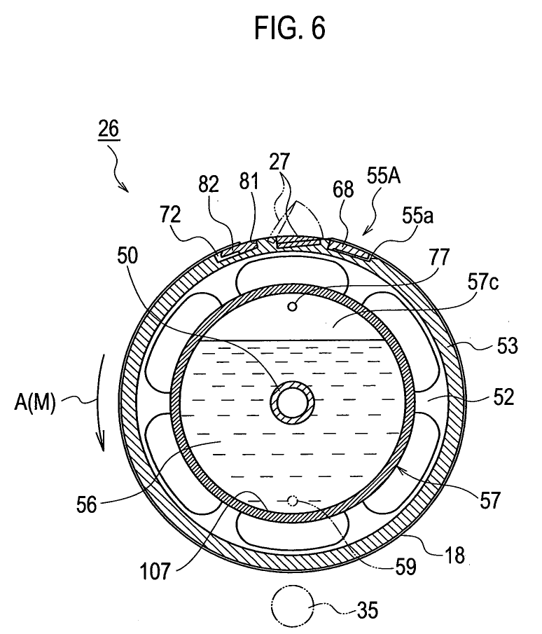

FIG. 2 is a perspective view illustrating a schematic configuration of the drum 26. FIG. 3 is a cross-sectional view taken along the line III-III in FIG. 2. FIG. 4 is a cross-sectional view taken along the line IV-IV in FIG. 3. FIG. 5 is a cross-sectional view taken along the line V-V in FIG. 3, and additionally illustrates first pipe 59 to be described later, communication holes 57d, 57e, and bottom surface 107 of a sub tank 57c by broken lines, respectively, for ease of understanding. FIG. 6 is a cross-sectional view taken along the line VI-VI in FIG. 3, and additionally illustrates a pipe 59 to be described later by a broken line for ease of understanding.

The drum 26 includes a supporting shaft 50 fixed to the machine body H (illustrated in FIG. 1), a pair of side disks 52 and 52 are supported so as to freely rotate around the supporting shaft 50 with each of bearings 51, and a cylindrical outer peripheral wall 53 fixed between the pair of side disks 52 and 52. The outer peripheral wall 53 is rotationally driven by a rotation force of the main motor 25 together with the pair of side disks 52 and 52. The outer peripheral wall 53 has rigidity to such a degree that no deformation occurs when it is pressed by the pressure roller 35 and is formed by an ink impermeable member which does not allow the ink 56 to permeate therethrough. It should be noted that, for example, for the purpose of forming an outer peripheral surface of the outer peripheral wall 53 having an even cylindrical surface, well-known surface processing of various types, for example, fluorine contained resin processing such as Teflon (registered trademark) processing, nickel plating, nickel-chrome plating, hot-dip galvanizing, anodic oxidation or the like may be performed, depending on the type of ink impermeable member.

The stencil sheet clamping section 27 is provided by utilizing a clamping concave portion 53a formed along an axial direction of the supporting shaft 50 of the outer peripheral wall 53. The stencil sheet clamping section 27 is rotatably supported at one of the ends thereof by the outer peripheral wall 53. The stencil sheet clamping section 27 is provided so as to protrude from the outer peripheral wall 53 in an unclamping state as illustrated by a virtual line in FIGS. 4 and 5, but so as not to protrude from the outer peripheral wall 53 in a clamping state illustrated by a solid line in FIGS. 4 and 5. Thus, the stencil sheet clamping section 27 is designed to be capable of clamping the stencil sheet 18 without protruding from the outer peripheral wall 53.

The outer peripheral wall 53 is rotated in a direction of an arrow A in FIGS. 2, 4, 5, and 6, and a starting point of printing is set to a position where the drum 26 is a little rotated from the stencil sheet clamp section 27. Thus, a rotating direction A corresponds to a printing direction M and an area below the starting point of printing is set as a printing area. In the first embodiment, a maximum printing area is set to a region where A3 size print paper can be printed. Then, the outer peripheral wall 53 is provided with an ink supply section 55A of an ink supply unit 54 and an ink collection section 72 of an ink collection unit 73.

The ink supply unit 54 includes an ink tank 57 which stores ink 56, a supply pump 58 which suctions the ink 56 in the ink tank 57, a first pipe 59 which supplies the ink 56 suctioned by the supply pump 58, the supporting shaft 50 to which one of the ends of the first pipe 59 is connected, in which an ink passage 60 is formed, and in which holes 61 are formed at 180° opposite positions to each other, a rotary joint 63 which is rotatably supported on the outer peripheral side of the supporting shaft 50 and in which a communication hole 62 communicable with the hole 61 is formed, a second pipe 64 which includes one end connected to the rotary joint 63 and the other end lead to the outer peripheral wall 53, and the ink supply section 55A to which the other end of the second pipe 64 is made open.

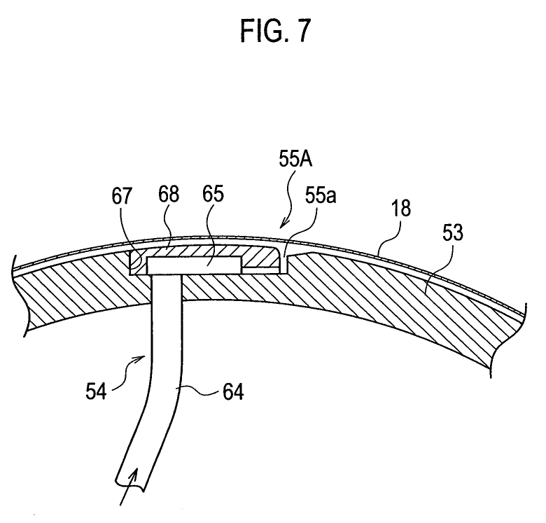

The ink supply section 55A includes an ink diffusion groove 65 (see FIG. 7) which diffuses the ink 56 from the second pipe 64 in a printing perpendicular direction N (see FIG. 2), and an ink supply port 55a (see FIG. 4) as an ink diffusion supply section with one end having openings at equal intervals in the printing perpendicular direction N of the ink diffusion groove 65 and the other end open to the surface of the outer peripheral wall 53. As illustrated in FIG. 7 (enlarged view of a VII portion in FIG. 4), the ink diffusion groove 65 and the ink supply port 55a are formed by an ink supply concave portion 67 formed along a direction perpendicular to the printing direction M (namely, the printing perpendicular direction N) of the outer peripheral wall 53, and by an ink distribution member 68 formed inside of the concave portion 67. The ink supply port 55a is formed along the printing perpendicular direction N and configured to supply the ink 56 almost uniformly in the printing perpendicular direction N of the outer peripheral wall 53.

Herein, the ink supply section 55A may be disposed at any of a position upstream of the maximum printing area in the printing direction, a position on a border between the maximum printing area and a non-printing area further upstream thereof, and an upstream position in the printing direction within the maximum printing area. Note that, when the ink supply section 55A is disposed at the position upstream of the maximum printing area in the printing direction, the position where the ink supply section 55A is disposed is set at a position downstream of the stencil sheet clamping section 27 in the printing direction. Meanwhile, in a case where the ink supply section 55A is disposed within the maximum printing area, the position where the ink supply section 55A is disposed is set to a position where the ink 56 to be supplied to the surface of the outer peripheral wall 53 can be diffused to at least the boarder between the maximum printing area and the further upstream non-printing area.

An ink collection unit 73 includes, as illustrated in FIGS. 2 and 4, an ink collection port 72 which is an ink collection section opened at the printing position downstream of the maximum printing area of the outer peripheral wall 53, a third pipe 74 with one end connected to the ink collection port 72, a rotary joint 63 with the other end of the third pipe 74 connected thereto and with a communication hole 75 formed, the supporting shaft 50 which rotatably supports the rotary joint 63 and has a hole 76a with which a communication hole 75 is communicable, and an ink passage 76b formed therein, a fourth pipe 77 with one of the ends connected to the supporting shaft 50, an ink tank 57 with the other end of the fourth pipe 77 is connected thereto, a fifth pipe 83 with one of the ends connected to an upper end portion in the ink tank 57 and being led outside the drum 26 through the supporting shaft 50, and a vacuum pump type collection pump 84 which is connected to the other end of the fifth pipe 83 and reduces pressure in the ink tank 57. The components of the ink collection unit 73, except the collection pump 84 and a part of the fifth pipe 83, are housed in the drum 26.

The ink collection port 72 is formed by using a concave portion 81 for ink collection which is continuously formed along the printing perpendicular direction N of the outer peripheral wall 53, and a pipe fixing member 82 formed therein.

The rotary joint 63 used herein is also used for the ink supply unit 54. The supporting shaft 50 has a double pipe structure as the supporting shaft 50 is used for an ink passage for the ink supply unit 54.

Next, the following will specifically explain the ink tank 57.

As illustrated in FIGS. 3, 5 and 6, the ink tank 57 has an approximately cylindrical shape, and is disposed in the drum 26 in a state where the supporting shaft 50 penetrates through the center of the cylindrical shape. An inside of the ink tank 57 is divided to have a main tank 57b whose cylindrical shape is partially lacking and the sub tank 57c by a partition wall 57a or the like. The unused ink 56 is stored in the main tank 57b, and the main tank 57b can be refilled with the ink 56 from the outside by a user. The other end of the first pipe 59 is connected to a lower portion of the sub tank 57c to allow the ink supply unit 54 to supply the ink 56 in the sub tank 57c to the drum 26. Moreover, the other end of the fourth pipe 77 is connected to an upper portion of the sub tank 57c, and the ink 56 collected by the ink collection unit 73 is returned to the inside of the sub tank 57c. In other words, during the printing operation, the ink 56 in the sub tank 57c is circulated by the ink supply unit 54 and the ink collection unit 73.

Moreover, in a lower portion and an upper portion of the partition wall 57a, there are formed communication holes 57d and 57e, each of which allows the main tank portion 57b and the sub tank portion 57c to communicate with each other. The lower communication hole 57d allows the ink 56 to flow between the main tank 57b and the sub tank 57c. One of the ends of the fifth pipe 83 is connected to the main tank 57b. The collection pump 84 directly reduces pressure of the main tank 57b, and reduces pressure of the sub tank 57c through the upper communication hole 57e, and the chamber pressure of the main tank 57b and the chamber pressure of the sub tank 57c will become equal to each other at some future time.

Hence, the ink 56 in the sub tank 57c of the ink tank 57 is supplied to the outer peripheral wall 53 of the drum 26, and the ink 56 unused for the printing is returned to the sub tank 57c. Accordingly, the ink 56 in the sub tank 57c is preferentially used. Then, when the volume of the used ink 56 in the sub tank 57c exceeds a certain volume, that is, when a liquid level difference between the tanks 57b and 57c exceeds a certain value, the ink 56 in the main tank 57b flows into the sub tank 57c through the communication hole 57d, and the sub tank 57c is refilled with the ink.

The vacuum pump 84 may be connected to either the main tank 57b or the sub tank 57c, however, is preferably connected to the main tank 57b so as to prevent the collected ink from being suctioned into the vacuum pump 84 without fail. Moreover, after the printing operation is completed, an internal pressure of the ink tank 57 may be returned to the atmospheric pressure. Furthermore, detection whether the volume of remaining ink is small or the ink 56 completely runs out may be performed by an ink residue detection unit such as an electrical sensor, an optical sensor, a sensor using a float or the like. Then, the tank 57b may be refilled with new ink (unused ink) 101 from the outside of the main tank 57b. Although not illustrated in FIG. 3, a hole for refilling the main tank 57b with the new ink may be formed, and the main tank 57b may be refilled with the ink by opening the hole at the time of refilling.

Next, operations of the above-configured stencil printing machine 100 will be briefly described.

First of all, when a stencil making mode is selected, in the stencil making unit 2, the stencil sheet 18 is conveyed by the rotation of the platen roller 21 and the stencil sheet transfer rollers 22. Based on the image data read out by the original reading unit 1, a number of heating elements of the thermal print head 20 selectively perform the heating operation, whereby the stencil sheet 18 is perforated due to the thermal sensitivity thereof to make a stencil. The stencil sheet 18 thus made is cut at a predetermined position by the stencil cutter 24. Thus, the stencil sheet 18 with the desired dimension is made.

In the printing unit 3, the leading edge of the stencil sheet 18 made by the stencil making unit 2 is clamped by the stencil clamping section 27 of the drum 26, and the drum 26 is rotated in such a clamping state, so that the stencil sheet 18 is wound, attached and loaded around the outer peripheral surface of the drum 26.

Next, when the printing mode is selected, in the printing unit 3, the drum 26 is rotationally driven, and the ink supply unit 54 and the ink collection unit 73 start driving. Then, the ink 56 in a sub tank 57c of the ink tank 57 is supplied from the ink supply port 55a to the outer peripheral wall 53, and the ink 56 thus supplied is held between the outer peripheral wall 53 and the stencil sheet 18 while the pressure roller 35 is shifted from the standby position to the press position.

The paper feed unit 4 feeds the print sheets 37 to a part between the drum 26 and the pressure roller 35 in synchronization with the rotation of the drum 26. The print sheets 37 thus fed are pressed onto the outer peripheral wall 53 of the drum 26 by the pressure roller 35, and conveyed by the rotation of the outer peripheral wall 53 of the drum 26. In other words, the print sheets 37 are conveyed while being brought into close contact with the stencil sheet 18.

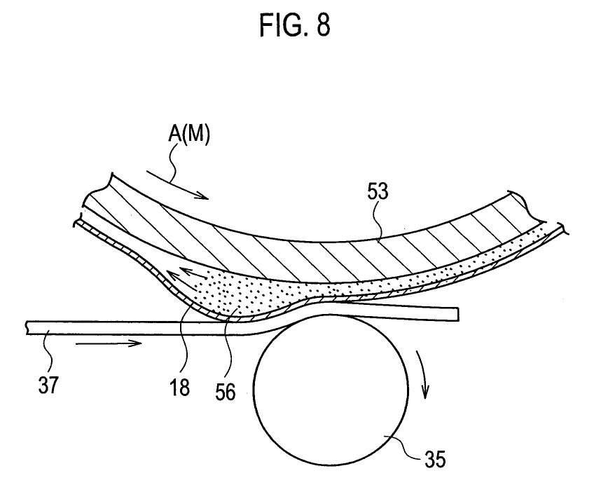

Moreover, at the same time when the print sheets 37 are conveyed, as illustrated in FIG. 8, the ink 56 held between the outer peripheral wall 53 of the drum 26 and the stencil sheet 18 is diffused downstream in the printing direction M while being squeezed by a pressing force of the pressure roller 35. The ink 56 thus diffused oozes off of the perforations of the stencil sheet 18, and is transferred to the print sheets 37 side. By this means, the ink image is printed on the print sheets 37 in the process where the print sheets 37 pass through the part between the outer peripheral wall 53 of the drum 26 and the pressure roller 35. The print sheets 37 which have come out from the part between the outer peripheral wall 53 of the drum 26 and the pressure roller 35, each of the leading edges thereof is peeled off from the drum 26 by the sheet separator claw 44. The print sheets 37 separated from the drum 26 are discharged through the conveying passage 45 to the paper receiving tray 46, and are stacked there.

Excess ink which has flown downstream of the maximum printing area of the outer peripheral wall 53 during the printing operation, flows into the ink collection port 72 of the ink collection unit 73 by a suction force of the collection pump 84, and the like. The ink 56 which has flown into the ink collection port 72 is collected into the sub tank 57c of the ink tank 57.

When printing of the set number of print sheets is completed, the rotation of the outer peripheral wall 53 of the drum 26 is stopped, and the drive of the ink supply unit 54 is stopped. As a result, the supply of the ink 56 to the outer peripheral wall 53 is stopped. The drive of the ink collection unit 73 is stopped a little later than the stop of the ink supply unit 54, and the excess ink which has remained on the outer peripheral wall 53, is collected through the ink collection port 72. Moreover, the pressure roller 35 is returned back to the standby position from the press position, and the stencil printing machine 100 enters a standby mode.

When making of a new stencil sheet is started, for example, and stencil disposal processing is thus started, the stencil clamping section 27 of the drum 26 is shifted to an unclamping position, and the unclamped leading edge side of the stencil sheet 18 is guided by the disposed stencil conveying unit 47, following the rotation of the drum 26, and housed in the stencil disposal box 48.

As described above, in the stencil printing machine 100, the ink 56 in the sub tank 57c of the ink tank 57 is supplied to the outer peripheral wall 53 of the drum 26, and the ink 56 unused for the printing is returned to the sub tank 57c. Accordingly, the ink 56 in the sub tank 57c is preferentially used. Then, when the volume of the used ink 56 in the sub tank 57c exceeds a certain volume, that is, when the liquid level difference between the main tank 57b and the sub tank 57c exceeds a certain value, the ink 56 in the main tank 57b flows into the sub tank 57c through the communication hole 57d, and the sub tank 57c is refilled with the ink 56.

When such operations are repeated and the volume of the ink 56 in the ink tank 57 becomes low, the user refills the main tank 57b with the unused ink 56. Even if the main tank 57b is refilled with the unused ink 56, the ink 56 in the sub tank 57c is preferentially supplied to the drum 26, and the ink 56 in the main tank 57b is supplied only in an auxiliary manner as described above. Accordingly, even before and after the ink refilling (bottle change in the case of an ink bottle), a printed state of the printed sheets does not change very much, and approximately even printed sheets can be obtained.

In the above-described embodiment, the ink supply unit 54 is configured to preferentially supply the ink 56 in the sub tank 57c in a manner that the ink 56 in the sub tank 57c is supplied to the ink supply section 55A and the sub tank 57c is refilled with only the volume of ink 56 equivalent to that of the ink used in the drum 26, from the main tank 57b. Accordingly, the collected ink 56 can be preferentially used without fail. Specifically, when the volume of the used ink 56 in the sub tank 57c exceeds a certain volume, that is, when the liquid level difference between the main tank 57b and the sub tank 57c exceeds a certain value, the ink 56 in the main tank 57b flows into the sub tank 57c through the communication hole 57d, and the sub tank 57c is refilled with the ink 56.

In the above-described embodiment, the ink supply unit 54 is configured to preferentially supply the ink 56 in the sub tank 57c in a manner that the main tank 57b and the sub tank 57c are set to be capable of flowing the ink 56 therebetween and that the chamber pressure in the main tank 57b and the chamber pressure in the sub tank 57c are set equal to each other. Accordingly, the preferential supply of the ink 56 can be achieved with a simple configuration with which the chamber pressures of both of the tanks 57b and 57c are merely kept equal to each other.

Furthermore, in the above-described embodiment, the ink tank 57 is disposed inside the drum 26, and therefore, it is not necessary to dispose various rollers for supplying the ink, an ink pool and the like in the drum 26. Accordingly, a large space for installing the ink tank 57 can be secured. Then, the entire machine can be made smaller in size by installing the ink tank 57 inside the drum 26.

Furthermore, in the above-described embodiment, the ink supply unit 54 and the ink collection unit 73 are always driven during the printing mode. Accordingly, the ink 56 is continuously supplied from the ink supply section 55A to the outer peripheral wall 53 during the printing mode, and the ink 56 which has entered the ink collection port 72 from the outer peripheral wall 53 is always collected. Accordingly, the ink 56 can be prevented at the earliest possible opportunity from residing on the outer peripheral wall 53. Moreover, an adequate volume of the ink 56 can always be maintained on the outer peripheral wall 53. Therefore, even when a large number of print sheets are continuously printed, printed sheets with a desired ink density can be obtained.

Moreover, in the above-described embodiment, the ink supply section 55A includes the ink supply port 55a having continuous openings along the printing perpendicular direction N of the outer peripheral wall 53. Accordingly, the ink 56 is diffused uniformly in the printing perpendicular direction N when the ink 56 is diffused downstream of the printing direction by being pressed by the pressure roller 35. Hence, density unevenness of the printing in the printing perpendicular direction N can be surely prevented. Here, the ink supply section 55A only has to be configured to be provided along the printing perpendicular direction N of the outer peripheral wall 53 and configured to be able to supply the ink 56 approximately uniformly in the printing perpendicular direction N, and various configurations are conceivable. For example, the ink supply section 55A may be configured to have opened multiple ink supply ports at equal intervals along the printing perpendicular direction N of the outer peripheral wall 53.

Furthermore, in the above-described embodiment, the ink collection port 72 as the ink collection portion is provided only at the portion downstream of the maximum printing area of the outer peripheral wall 53 in the printing direction. However, a configuration may be employed, in which ink collection grooves are provided at outer positions on left and right sides of the maximum printing area in the printing perpendicular direction N, and the ink collection grooves are continuously provided to the ink collection port 72. With such a configuration, the ink 56 leaking from the sides of the maximum printing area can be collected, and the ink leakage from the sides can be prevented. Moreover, another configuration may be employed, in which an ink collection groove is provided at a position which is upstream of the maximum printing area in the printing direction and downstream of the stencil clamping section 27 in the printing direction, and the ink collection groove is continuously provided to the ink collection port 72. With such a configuration, the ink leaking from the top of the maximum printing area can be collected, and the ink leakage from the top can be prevented.

Furthermore, in the above-described embodiment, the stencil clamping section 27 does not protrude from the surface of the outer peripheral wall 53 of the drum 26, and therefore, the pressure roller 35 can be driven easily. Namely, during the printing mode, this eliminates the need to shift the pressure roller 35 between the press position and the standby position for each rotation of the drum 26 to avoid collision of the pressure roller 35 against the stencil clamping section 27.

By this means, malfunctions such as noise caused by the pressure roller 35 and image quality deterioration caused by a rebound thereof can be solved.

Here, the following will more specifically explain the ink tank 57 and the like with reference to FIG. 3 and like.

As described above, the ink tank 57 includes the main tank 57b and the sub tank 57c. The main tank 57b stores (reservoirs) unused ink 101. The sub tank 57c is configured so that a bottom surface 107 of the sub tank 57c is located lower than a bottom surface 109 of the main tank 57b so as to receive supply of the unused ink 101 from the main tank 57b by the action of gravity (water head difference).

The ink supply unit 54 supplies ink 105 stored (reservoired) in the sub tank 57c to the printing unit 3, and the printing unit 3 transfers the ink to a printing medium (for example, printing is performed on paper by using ink).

The ink collection unit 73 collects and returns excess ink 103 to the sub tank 57c, which is supplied to the printing unit 3 by the ink supply unit 54 and which remains without being used for transferring onto the printing medium by the printing unit 3.

It should be noted that ink to be stored in the sub tank 57c is mixed ink 105 in which the excess ink 103 collected by the ink collection unit 73 and the unused ink 101 stored in the main tank 57b are mixed. The mixed ink 105 is supplied to the printing unit 3 by the ink supply unit 54.

When the unused ink 101 is left in the main tank 57b, the liquid level (upper surface) of the unused ink 101 in the main tank 57b and the liquid level (upper surface) of the ink 105 in the sub tank 57c are present on the same horizontal plane.

Here, a case in which the unused ink 101 is left in the main tank 57b means a state in which the liquid level of the unused ink 101 in the main tank 57b is present above a bottom surface 109 of the main tank 57b, and therefore the ink 101 can be supplied to the sub tank 57c. When only ink sticking on the wall surface of the main tank 57b is present, no unused ink is left in the main tank 57b.

Moreover, the printing unit 3 does not use all mixed ink 105 supplied by the ink supply unit 54, but uses only part of the ink for transferring onto the printing medium. Then, the ink collection unit 73 collects and returns the ink 103, which has not been used for printing onto paper, (ink which has not been transferred onto paper) to the sub tank 57c.

Furthermore, the main tank 57b and the sub tank 57c are formed to have an appropriate shape adapting to the form of the device (the stencil printing machine 100 in this embodiment) in which these tanks are installed.

The following will further explain the ink tank 57 or the like using examples.

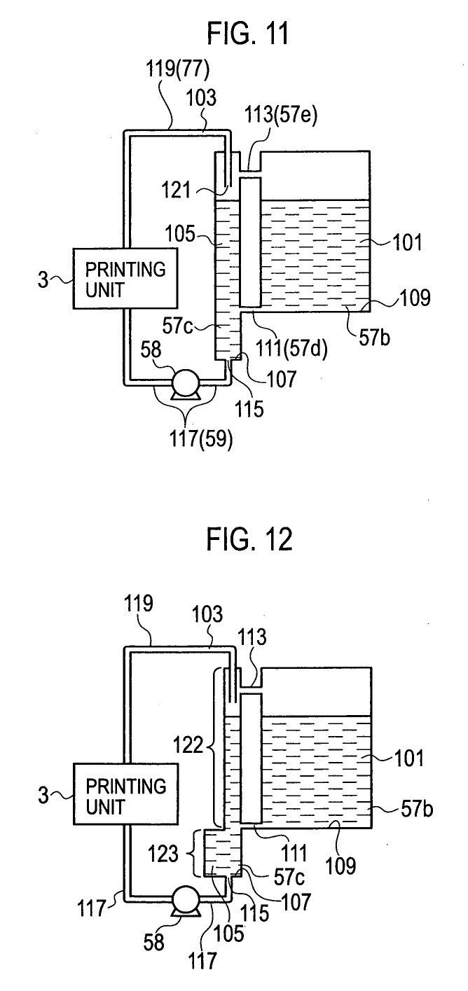

FIGS. 11 to 16 are views each illustrating a schematic configuration of the ink tank 57 and the like.

In FIG. 11, the main tank 57b is formed to have a rectangular parallelepiped or cylindrical shape whose interior is hollow to store the ink (its axis may extend in a vertical or horizontal direction).

The sub tank 57c is also formed to have a rectangular parallelepiped or cylindrical shape whose interior is hollow to store the ink. Additionally, in the sub tank 57c cylindrically shaped, the height direction of the cylinder is defined as a vertical direction. Moreover, regarding the volume of the internal space where the ink is stored, for example, the main tank 57b is designed to have a larger volume than that of the sub tank 57c and can store more ink than the sub tank 57c.

The height of the upper end (upper surface of the inner wall) of the sub tank 57c and that of the upper end (upper surface of the inner wall) of the main tank 57b are approximately equal to each other, for example. The bottom surface (lower surface of the inner wall) of the sub tank 57c is located lower than that (bottom surface of the inner wall) of the main tank 57b.

An ink supply passage 111 (57d), which communicates with the sub tank 57c, is formed at a lower end of the main tank 57b. The ink supply passage 111 extends approximately horizontally. Then, the unused ink 101 can be supplied to the sub tank 57c from the main tank 57b through the ink supply passage 111 until the unused ink 101 in the main tank 57b runs out. The ink supply passage 111 has a cross-sectional area of a passage for flowing the ink 101, which is smaller than that of the sub tank 57c (cross-sectional area of the internal space of the sub tank 57c taken along a horizontal plane), thus forming, for example, a throttle (a throttle valve such as an orifice or choke or the like).

It should be noted that the ink supply passage 111 may have a check valve that prevents ink from flowing back into the ink supply passage 111. By providing the check valve, the ink flows into the sub tank 57c from the main tank 57b, but does not flow into the main tank 57b from the sub tank 57c, so that the collected ink 103 collected by the ink collection unit 73 can be preferentially supplied to the ink supply section 55A without fail.

At the upper end of each of the main tank 57b and the sub tank 57c or in the vicinity thereto, there is provided an air passage 113 (57e) that connects the sub tank 57c and the main tank 57b to each other. Accordingly, when the unused ink 101 is left in the main tank 57b, only the unused ink 101 of a volume equivalent to a volume consumed by the printing unit 3 (a volume of ink used for transferring onto the printing medium) is supplied to the sub tank 57c from the main tank 57b. Moreover, there is a case in which the ink 105 is bubbled in the sub tank 57c when the collected ink 105 drops on the liquid level of the ink 105 in the sub tank 57c. In even such a case, it is possible to prevent the bubble ink from entering the main tank 57b from the air passage 113 because the air passage (air channel) 113 is provided at the upper portion.

In addition, when no unused ink 101 is left in the main tank 57b, the liquid level of the ink 105 in the sub tank 57c is located lower than the bottom surface 109 of the main tank 57b.

The ink supply unit 54 is configured to supply the ink to the printing unit 3 from the sub tank 57c through an ink supply passage 117 (pipe 59 for ink) where an ink suction port 115 communicates with the sub tank 57c and by using the ink pump 58. The ink suction port 115 of the ink supply passage 117 is located at the bottom surface of the sub tank 57c. In addition, the supply of the unused ink 101 to the sub tank 57c from the main tank 57b is made mainly by the action of gravity. However, the ink pump 58 is provided, and therefore the supply of the unused ink 101 to the sub tank 57c from the main tank 57b is promoted by the ink pump 58.

The ink collection unit 73 is configured to return the ink 103 to the sub tank 57c through an ink collection passage 119 (ink is passed through an ink pipe 77 where an ink discharge port 121 enters the sub tank 57c). The ink pipe 77 extends downward from the upper end of the sub tank 57c in the sub tank 57c through the upper end wall of the sub tank 57c. The lower end of the pipe 77 is located slightly lower than the air passage 113 that connects the main tank 57b and the sub tank 57c to each other. Then, the ink 103 drops from the lower end of the ink pipe 77 and returns to the sub tank 57c.

In FIG. 12, the sub tank 57c consists of an upper side portion 122 and a lower side portion 123, and the cross-sectional area of the upper side portion 122 taken along a horizontal plane is smaller than that of the lower side portion 123 taken along a horizontal plane.

The position in the height direction of the boarder between the upper side portion 122 and the lower side portion 123 is approximately equal to the height of the bottom surface 109 of the main tank 57b, however, the boundary may be located above or below the bottom surface 109 of the main tank 57b. Additionally, as is already understood, the sub tank 57c consisting of the upper side portion 122 and the lower side portion 123 in FIG. 12 corresponds to one in which the sub tank 57c illustrated in FIG. 11 is formed by the upper side portion 122 and the lower side portion 123, and the cross-sectional area of the internal space of the upper side portion 122 (cross-sectional area taken along a horizontal plane) is made smaller than that of the internal space of the lower side portion 123 (cross-sectional area taken along a horizontal plane).

Moreover, the ink supply passage 111 provided at the lower end of the main tank 57b communicates with the sub tank 57c at the lower end of the upper side portion 122 of the sub tank 57c.

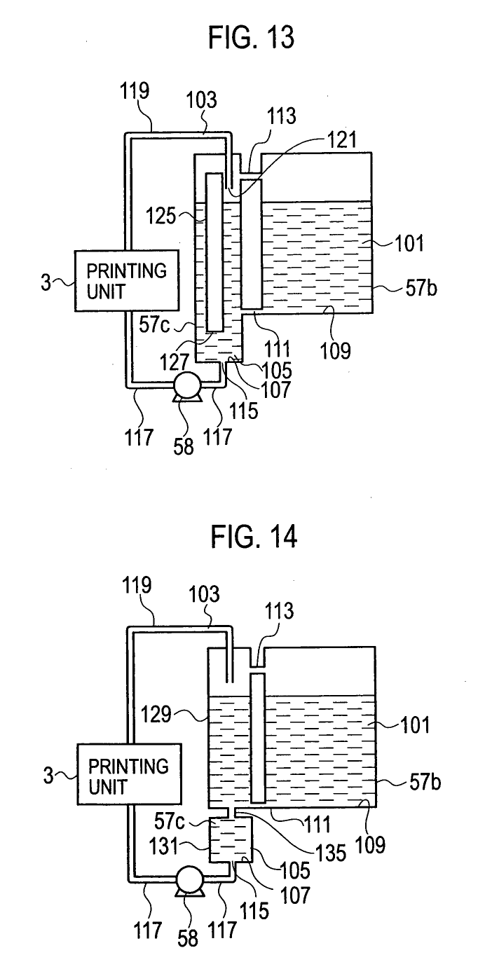

In FIG. 13, at a place where the ink 103 is returned to the sub tank 57c by the ink collection unit 73, the sub tank 57c is configured to be divided into multiple portions (for example, two), and the ink 103 is returned to one of divided portions by the ink collection unit 73, in the configuration.

In other words, FIG. 13 illustrates a configuration in which the sub tank 57c illustrated in FIG. 11 is configured so that an inside member (inside member provided in the sub tank 57c) 125 is provided integrally with the cylinder of the sub tank 57c. At a portion where the inside member 125 is provided, the interior of the sub tank 57c is divided into, for example two.

A lower end 127 of the inside member 125 is located lower than the bottom surface 109 of the main tank 57b and the upper end of the inside member 125 is located close to the upper end of the sub tank 57c. Therefore, the space in the sub tank 57c is not divided in a portion from the lower end to the vicinity thereof and from the upper end to the vicinity thereof. Instead, the space in the sub tank 57c is divided into two at an intermediate portion in a vertical direction.

The ink collection unit 73 is configured to return the ink 103 to the sub tank 57c through the ink collection passage 119 where the ink discharge port 121 of the ink 103 enters the sub tank 57c. In the sub tank 57c, the ink collection passage 119 extends downward, penetrating the upper end of the sub tank 57c. The lower end of the ink collection passage 119 (ink discharge port 121 of the ink collection passage 119) is located slightly lower than the air passage 113 that connects the main tank 57b and the sub tank 57c to each other. The ink discharge port 121 of the ink collection passage 119 is located lower than the upper end of the inside member 125. Namely, the ink discharge port 121 of the ink collection passage 119 is present at one of the two divided portions. Additionally, in FIG. 13, the ink collection passage 119 is present on the main tank 57b side (right side of the inside member 125). However, the ink collection passage 119 may be present on an opposite side to the main tank 57b (left side of the inside member 125). Then, the ink drops on one side of the sub tank 57c from the lower end 121 of the ink collection passage 119, in the configuration.

As is already understood, the portion of the sub tank 57c to which the ink collection unit 73 returns the ink 103 ranges from the lower end 121 of the ink collection passage 119 in the sub tank 57c to the bottom surface 109 of the main tank 57b in a vertical direction. In other words, in the ordinary use state of the stencil printing machine 100, the liquid level (upper surface) of the ink 103 in the sub tank 57c (main tank 57b) is present within the aforementioned range.

Additionally, although not illustrated in FIG. 13, at a portion where the inside member 125 extends in a direction perpendicular to a drawing surface in FIG. 13, both ends of the inside member 125 in a width direction of the inside member 125 (direction perpendicular to the drawing surface in FIG. 13) come in contact with an outer skin (housing) that forms the internal space (space where ink is stored) of the sub tank 57c and the inside member 125 is provided, the sub tank 57c is completely divided into two. Thus, the space where the mixed ink 105 in the sub tank 57c is housed is formed in an annular shape as illustrated in FIG. 13. By contrast, a configuration may be possible in which both ends of the inside member 125 in the width direction do not come in contact with the housing. By this means, a cylindrical space is formed in the sub tank 57c at the portion where the inside member 125 is provided.

In FIG. 14, the sub tank 57c consists of an upper sub tank 129 and a lower sub tank 131, and the upper sub tank 129 and lower sub tank 131 are connected to each other through a throttle valve 135 (orifice or choke). Hence, the sub tank 57c is configured to supply ink to the upper sub tank 129 from the main tank 57b. Furthermore, the ink collection unit 73 is configured to return the ink 103 to the upper sub tank 129, and the ink supply unit 54 is configured to supply the ink 105 stored in the lower sub tank 131 to the printing unit 3.

Moreover, in the height direction, for example, the upper end (upper surface of the inner wall) of the upper sub tank 129 is disposed at approximately the same position as the upper end (upper surface of the inner wall) of the main tank 57b. The lower end (bottom surface of the inner wall) of the upper sub tank 129 is disposed at approximately the same position as the lower end (bottom surface of the inner wall) 109 of the main tank 57b, for example. Moreover, the lower sub tank 131 is located lower than the upper sub tank 129 and the upper end of the lower sub tank 131 is located slightly lower than the lower end of the main tank 57b. The throttle valve 135 connects the lower end of the upper sub tank 129 and the upper end of the lower sub tank 131 to each other.

Furthermore, in FIG. 14, the cross-sectional area of the upper sub tank 129 taken a horizontal plane is approximately the same as that of the lower sub tank 131 taken along a horizontal plane. Accordingly, it can be said that FIG. 14 illustrates a configuration in which the sub tank 57c illustrated in FIG. 11 is divided into two tanks of the upper sub tank 129 and the lower sub tank 131 at approximately the same height as that of the bottom surface 109 of the main tank 57b and those tanks are connected to each other by the throttle valve 135.

In addition, the lower end of the main tank 57b and the lower end of the upper sub tank 129 are connected to each other by the ink passage 111, and the unused ink 101 is supplied to the upper sub tank 129 from the main tank 57b. Hence, ink flowing into the lower sub tank 131 is the mixed ink 105 where the collected ink 103 and new ink (unused ink) 101 are mixed, and more stable printed sheets can be obtained. Namely, it is possible to prevent the new ink 101 refilled from the main tank 57b from being supplied to the printing unit 3 before being mixed with the collected ink 103 well.

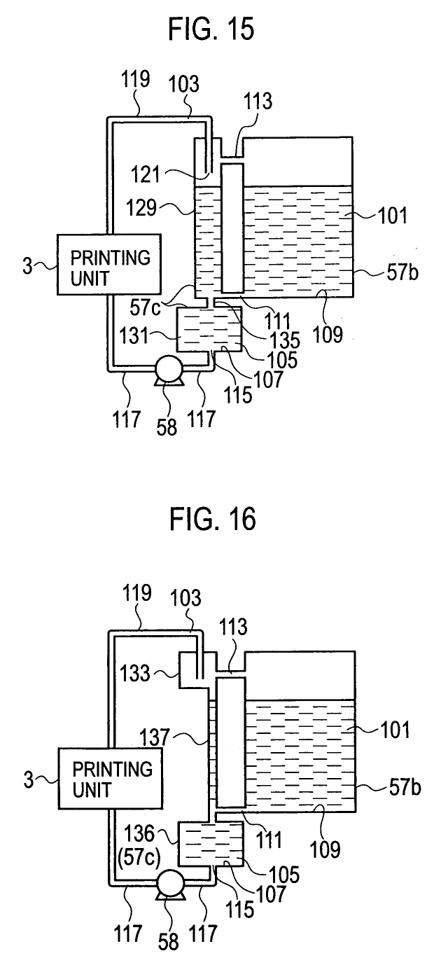

A configuration illustrated in FIG. 15 is one in which the cross-sectional area of the upper sub tank 129 taken along a horizontal plane in FIG. 14 is made smaller than that of the lower sub tank 131 taken along a horizontal plane.

Additionally, in configurations illustrated in FIGS. 14 and 15, the upper sub tank 129 and the lower sub tank 131 are close to each other, but they may be largely separated away from each other.

Moreover, in configurations illustrated in FIGS. 12, 14 and 15, the main tank 57b and the upper sub tank 129 (upper side portion 122) are connected to each other in order to refill the sub tank 57c with the ink 101 from the main tank 57b. However, the main tank 57b and the lower sub tank 131 (lower side portion 123) may be connected to each other.

Furthermore, in the configurations illustrated in FIGS. 12, 14 and 15, similar to the configuration illustrated in FIG. 13, at a place where the ink 103 is returned to the upper sub tank 129 (upper side portion 122) by the ink collection unit 73, the upper sub tank 129 (upper side portion 122) may be divided into multiple portions so that the ink is returned to one of the multiple portions by the ink collection unit 73.

In FIG. 16, a collected ink receiver 133 is added to the configuration illustrated in FIG. 11 and the forms of the other portions are modified correspondingly.

In other words, in FIG. 16, the collected ink receiver 133, which receives the excess ink 103 returned from the printing unit 3 by the ink collection unit 73, is provided and a sub tank 136 (57c) is configured to receive the ink 103 from the collected ink receiver 133 through an ink passage 137 that connects the sub tank 136 and the ink receiving section 133 to each other.

The upper end of the sub tank 136 is located slightly lower than the bottom surface 109 of the main tank 57b, for example.

The collected ink receiver 133 is also a tank having a space therein, similar to the sub tank 57c or the like. The upper end of the collected ink receiver 133 is located at approximately the same height as that of the upper end of the main tank 57b, and the lower end of the collected ink receiver 133 is located above the bottom surface 109 of the main tank 57b at a position lower than the upper end of the main tank 57b. The ink passage 137 extends vertically and connects the lower end of the collected ink receiver 133 and the upper end of the sub tank 136 to each other. The cross-sectional area of the ink passage 137 (cross section taken along a plane perpendicular to an extension direction of the ink passage 137: cross section taken along a horizontal plane) is small in comparison with that of the collected ink receiver 133 or the sub tank 136. In other words, the ink passage 137 forms a throttle valve such as a choke or the like. The collected ink receiver 133 and the upper portion of the main tank 57b are connected to each other by the air passage 113, and the lower end of the main tank 57b and the ink passage 137 are connected to each other by the ink supply passage (ink passage) 111, so that the unused ink 101 can be supplied to the sub tank 136 from the main tank 57b.

In FIG. 16, the bottom surface of the collected ink receiver 133, on which the ink 103 collected and returned by the ink collection unit 73 drops, forms a horizontal surface, however, a configuration may be possible in which the bottom surface is obliquely formed. Such an oblique configuration makes it possible to reduce an impact force occurring when the ink 103 is dropped on the collected ink receiver 133 and thereby to avoid possibility that fine bubbles are generated in the ink, as much as possible.

Herein, by referring to FIG. 3 and the like again, the stencil printing machine 100 will be more specifically explained.

As described above, the stencil printing machine 100 includes the drum 26, the ink supply unit 54, the ink collection unit 73 and the pressure roller 35. The drum 26 is rotatable and has the outer peripheral wall 53 formed by the ink impermeable member, and the stencil sheet 18 is wound around the surface of the outer peripheral wall 53. The ink supply unit 54 has the ink supply section 55A in the outer peripheral wall 53 of the drum 26 so as to supply the ink guided from the ink tank 57 to the surface of the outer peripheral wall 53 by the ink supply section 55A. The ink collection unit 73 has the ink collection section 72 in the outer peripheral wall of the drum 26 so as to return the excess ink on the surface of the outer peripheral wall 53 to the ink tank 57 from the ink collection section 72. The pressure roller 35 presses the fed printing medium onto the outer peripheral wall 53.

Furthermore, in the stencil printing machine 100, the ink tank 57 has the main tank 57b which stores the unused ink 101, and the sub tank 57c which stores the ink 103 collected by the ink collection unit 73 and the unused ink 101 from the main tank 57b. The ink supply unit 54 is configured to preferentially supply the ink 105 in the sub tank 57c (i.e. supply the ink 105 in the sub tank 57c before the unused ink 101 in the main tank 57b), and the approximately horizontal bottom surface 107 of the sub tank 57c is located lower than the bottom surface 109 of the main tank 57b.

According to the stencil printing machine 100, the bottom surface 107 of the sub tank 57c is located lower than the bottom surface 109 of the main tank 57b, and therefore even if the ink (unused ink) 101 in the main tank 57b runs out, the mixed ink 105 is left in the sub tank 57c. Then, even if the main tank 57b is refilled with the unused ink 101 after the volume of the ink (unused ink) 101 remaining in the main tank 57b is low or the ink 101 completely runs out, printing after the refilling is performed with mainly the mixed ink 105 left in the sub tank 57c. Therefore, the main tank 57b need not be frequently refilled with the unused ink 101 and there may be no need to have a complicated configuration in which a device such as a sensor for detecting the volume of unused ink 101 in the main tank 57b is separately provided. Namely, it is possible, with a simple configuration, to suppress occurrence of a change in the print state of the printed sheet between before and after the main tank 57b is refilled with the unused ink 101, so that print quality is easily made uniform. This makes it possible to achieve reduction in size and cost reduction of the stencil printing machine 100 and decrease the amount of electric consumption.

Moreover, according to the stencil printing machine 100 illustrated in FIG. 12, the cross-sectional area of the upper side portion 122 is smaller than that of the lower side portion 123. Therefore, even if the main tank 57b is refilled with the unused ink 101 after the volume of the ink 101 remaining in the main tank 57b is low or the ink 101 runs out, it is possible to suppress the volume of new ink 101 flowing into the sub tank 57c. Hence, it is possible to further suppress occurrence of a change in the print state of the printed sheet before and after refilling the main tank 57b with the ink.

Namely, in comparison between the sub tank illustrated in FIG. 11 and that illustrated in FIG. 12, when the main tank 57b is refilled with the unused ink 101 after the ink 101 in the main tank 57b runs out, the volume of the unused ink 101 to be supplied to the sub tank 57c in FIG. 12 tends to be smaller than that in FIG. 11. In other words, a ratio of the unused ink 101 to the mixed ink 105 left in the sub tank 57c in FIG. 12 (the volume of unused ink flowing into the sub tank 57c from the main tank 57b when the main tank 57b is refilled with the unused ink 101) tends to be smaller than that in FIG. 11. Therefore, a change in the compound ratio of the mixed ink 105 in the sub tank 57c before and after refilling the main tank 57b with the ink becomes small, so that the change in the print state of the printed sheet can be suppressed further.

Furthermore, the stencil printing machine 100 illustrated in FIG. 13 has a configuration in which the ink 103 is returned to one portion of the multiple divided portions (one portion in the sub tank 57c) by the ink collection unit 73. Therefore, even if the ink 103 is dropped on the one portion and fine bubbles are generated in the ink to move the bubbles to the lower portion of the sub tank 57c, the moved bubbles float from any other portion of the divided multiple portions and easily escape to the space of the upper portion in the sub tank 57c (space filled with air). Thereby, it is possible to suppress residence of the bubbles in the sub tank 57c and achieve stable printing.

Furthermore, even if the ink 103 is dropped on one portion so that fine bubbles are generated in the ink, and the dropped ink 103 does not easily move downward due to the bubbles to make it difficult to be mixed with the unused ink 101 or the mixed ink 105, the ink 105 existing in the other portion is mixed with the unused ink 101. Accordingly, it is possible to further suppress occurrence of a change in the print state of the printed sheet before and after refilling the main tank 57b with the ink.

Moreover, according to the stencil printing machine 100 illustrated in FIG. 14, the upper sub tank 129 and the lower sub tank 131 are connected to each other through the throttle valve 135. Therefore, the collected ink 103 (ink collected by the ink collection unit 73) and new ink (unused ink) 101 are surely mixed with each other, so that more stable printed sheets can be obtained. Namely, the new ink 101 refilled from the main tank 57b can be prevented from being supplied to the printing unit 3 before being well mixed with the collected ink (excess ink) 103.

More specifically, when the main tank 57b is refilled with the unused ink 101 after the ink 101 in the main tank 57b runs out, the unused ink 101 is supplied to the upper sub tank 129 by the provision of the throttle valve 135, but is not immediately moved to the lower sub tank 131. Namely, the unused ink 101 is moved to the lower sub tank 131 after well mixed with the ink 103 collected by the ink collection unit 73 in the upper sub tank 129. Therefore, the ink surely mixed is supplied to the printing unit 3 by the ink supply unit 54, so that more stable printed sheets can be obtained.

Moreover, the upper sub tank 129 and the lower sub tank 131 are connected to each other through the throttle valve 135. Therefore, almost all fine bubbles which exist in the ink in the upper sub tank 129, (for example, bubbles generated when the ink 103 is dropped in the upper sub tank 129 by the ink collection unit 73), rise in the upper sub tank 129 and disappear without entering the lower sub tank 131, so that more stable printed sheets can be obtained.

As described above, the configuration illustrated in FIG. 15 is one in which the cross-sectional area of the upper sub tank 129 taken along a horizontal plane in FIG. 14 is made smaller than that of the lower sub tank 131 taken along a horizontal plane. According to the stencil printing machine 100 illustrated in FIG. 15, the cross-sectional area of the lower sub tank 131 taken along a horizontal plane is larger than that of the upper sub tank 129 taken along a horizontal plane. Therefore, even if the main tank 57b is refilled with the unused ink 101 after the volume of the ink 101 in the main tank 57b is low or the ink 101 runs out, it is possible to suppress the volume of new ink 101 flowing into the sub tank 57c. Hence, it is possible to further suppress an occurrence of a change in the print state of the printed sheet between before and refilling the main tank 57b with the ink.

Furthermore, according to the stencil printing machine 100 illustrated in FIG. 16, the collected ink receiver 133 is provided, thus making it possible to prevent ink containing fine bubbles from being supplied to the sub tank 136 without fail.

### Second Embodiment

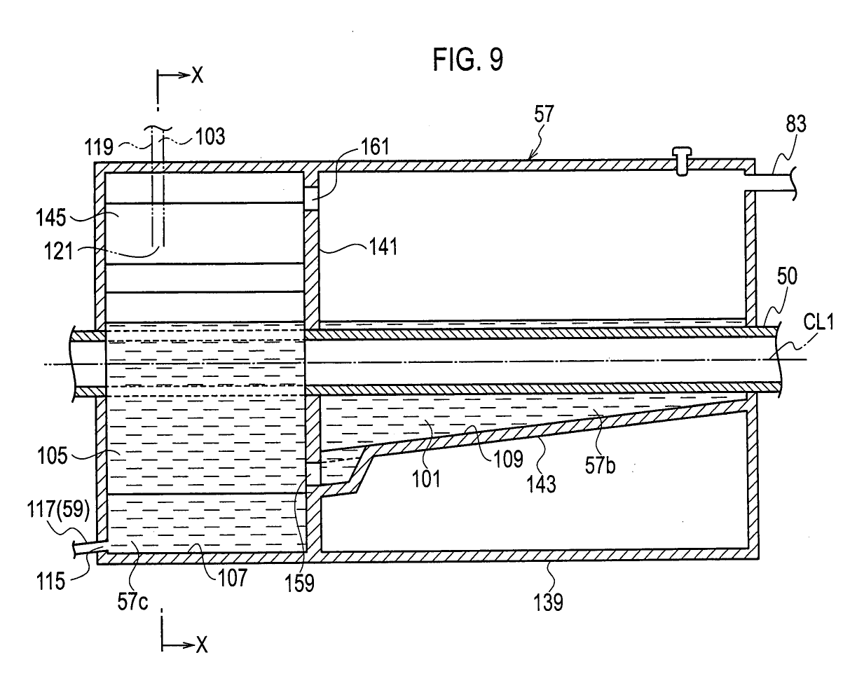

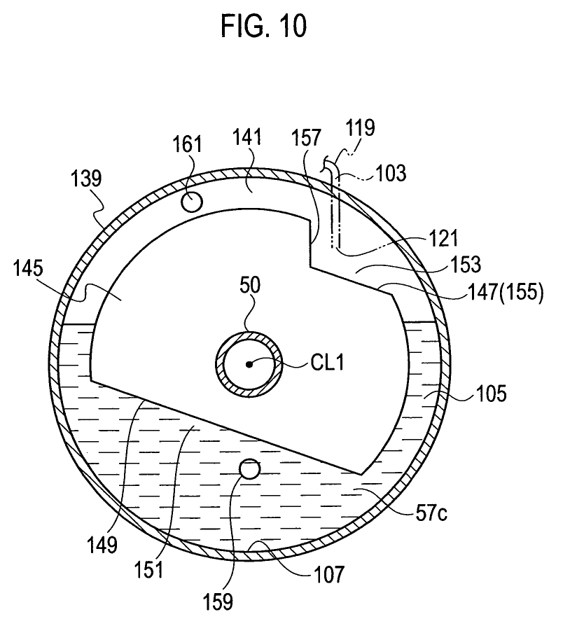

FIG. 9 is a view illustrating a schematic configuration of the ink tank 57 and the like used in a stencil printing machine according to a second embodiment of the present invention, and corresponding to parts near the ink tank 57 in FIG. 3 and FIG. 13. FIG. 10 is a view illustrating a cross section taken along the line X-X in FIG. 9.

The stencil printing machine according to the second embodiment differs from the stencil printing machine 100 according to the first embodiment (illustrated in FIG. 3) in that the bottom surface 109 of the main tank 57b is obliquely inclined. The other portions are configured in approximately the same manner as those of the stencil printing machine 100 according to the first embodiment, and modification can be made in the same manner, thus exhibiting almost the same effect as in the first embodiment.

Specifically, the stencil printing machine according to the second embodiment includes a drum (not illustrated in FIGS. 9 and 10). The drum, as described above, has a cylindrical outer shape and a cylindrical internal space, and is supported so as to freely rotate around the cylindrical supporting member (shaft) 50. Moreover, the drum has an outer peripheral wall which is formed by an ink impermeable member, around an outer cylindrical shape side portion, and a stencil sheet is attached onto the surface of the outer peripheral wall.

Furthermore, the stencil printing machine according to the second embodiment has an ink tank configuration member 139. The ink tank configuration member 139 whose outer shape is cylindrically formed, has a cylindrical internal space. Then, the ink tank configuration member 139 is provided integrally with the supporting member 50 on an inner side of the drum. In addition, a central axis CL1 of the ink tank configuration member 139 coincides with that of the supporting member 50.

The main tank 57b is formed in an internal space surrounded by the ink tank configuration member 139, and is surrounded by a partition wall 141, a bottom configuration member 143 and the ink tank configuration member 139. The partition wall 141 is plate-like shaped, formed in a direction perpendicular to the central axis CL1 of the drum, and is formed integrally with the ink tank configuration member 139 and the supporting member 50 on an inner side of the ink tank configuration member 139 so as to divide the internal space of the ink tank configuration member 139. The bottom configuration member 143 is plate-like shaped and is formed integrally with the ink tank configuration member 139 and the partition wall 141 in a first internal space having a larger volume of the two internal spaces of the ink tank configuration member 139 divided by the partition wall 141. Moreover, the bottom configuration member 143 is located lower than the supporting member 50, and one end of the bottom configuration member 143 disposed on the partition wall 141 side is located lower than the other end disposed on an opposite side to the partition wall 141. Thus, the bottom surface 109 of the main tank 57b is obliquely inclined.

The sub tank 57c is annularly formed by: a second internal space having a smaller volume of the two internal spaces of the ink tank configuration member 139 divided by the partition wall 141; and an inner member 145 provided in the second internal space at an intermediate portion in a height direction of the second internal space. The inner member 145 has an upper inclined surface 147 at the upper portion thereof and a lower inclined surface 149 at the lower portion thereof.

More specifically, the second internal space of the internal spaces of the ink tank configuration member 139 divided by the partition wall 141 is cylindrically formed. The inner member 145 is formed to have a shape with a first cut portion 151 and a second cut portion 153 formed on material which is cylindrically shaped to have a height (length) equal to that of the second internal space and an outer diameter smaller than the inner diameter of the second internal space.

Seen from the length direction of the material (direction perpendicular to the circular bottom surface), the first cut portion 151, as illustrated in FIG. 10, is linearly formed away from the center CL of the circular material. Meanwhile, the second cut portion 152 is formed in V shape and away from the center CL of the material at the position opposite to the first cut portion 151 through the center CL1 of the material.

The inner member 145 is formed integrally with the partition wall 141, the ink tank configuration member 139 and the supporting member 50 in a manner that the central axis CL1 of the inner member 145 (central axis of the material) and the central axis CL1 of the supporting member 50 (central axis of the sub tank 57c) coincide with each other. Moreover, the inner member 145 is provided in a manner that the first cut portion 151 is located at the lower portion and inclined to thereby form the lower inclined surface 149, and the second cut portion 153 is located at the upper portion and one surface 155 of the second cut portion 153 forms the upper inclined surface 147. The upper inclined surface 147 and the lower inclined surface 149 are approximately parallel to each other. Furthermore, as is already understood, the upper inclined surface 147 and the lower inclined surface 149 are each formed in a direction parallel to an extension direction of the central axis CL1 of the cylindrical internal space of the ink tank configuration member 139. The other surface 157 of the second cut portion 153 further is formed in a vertical direction.

Furthermore, the lower end of the lower inclined surface 149 is located at the lowest position of the inner member 145 and is located lower than the bottom surface 109 of the main tank 57b (portion where the bottom surface 109 meets the partition wall 141: the lowest portion of the bottom 109). The upper end of the lower inclined surface 149 is located lower than the lower end of the second cut portion 153 (lower end located higher than the central axis CL1 of the supporting member 50), and is located, for example, slightly lower than the central axis CL1 of the supporting member 50.

A lower through hole 159 is formed at approximately the same height as the bottom surface 109 of the main tank 57b (portion where the bottom surface 109 meets the partition wall 141) or at a position slightly lower than the bottom surface 109, and penetrates the partition wall 141. Then, when the liquid level of the ink 105 in the sub tank 57c is located lower than the bottom surface 109 of the main tank 57b, the space in the main tank 57b and the space in the sub tank 57c are connected to each other so that the unused ink 101 is prevented from being left in the main tank 57b, that is, almost all unused ink 101 in the main tank 57b is made to flow into the sub tank 57c by gravity.

Moreover, an upper through hole 161 is formed on the partition wall 141. The upper through hole 161 is formed to penetrate the partition wall 141 at the upper portion of the sub tank 57c and that of the main tank 57b (in the vicinity of the upper end). By this means, the space in the main tank 57b and the space in the sub tank 57c are connected to each other.

The ink supply unit 54, as described above, is configured to supply the ink guided from the lower end of the sub tank 57c to the surface of the outer peripheral wall of the drum from the ink supply section (ink supply section formed in the outer peripheral wall of the drum). Additionally, the ink collection unit 73, as mentioned above, is configured to collect the excess ink on the surface of the peripheral wall of the drum from the ink collection section 72 (ink collection section formed in the outer peripheral wall of the drum) and then to drop the collected ink on the upper inclined surface 147 to return to the sub tank 57c. The pressure roller 35 is configured to press the fed printing medium onto the outer peripheral wall of the drum.

Then, when the printer according to the second embodiment starts printing in a state that the mixed ink 105 is stored in the sub tank 57c while the unused ink 101 is stored in the main tank 57b, the mixed ink 105 in the sub tank 57c is supplied to a printing section (drum) through the ink supply passage 117, and the excess ink on the printing section is dropped on the upper inclined surface 147 through the ink collection passage 119 and then is returned to the sub tank 57c. Moreover, the volume of the unused ink 101 which corresponds to that of mixed ink 105 used for printing by the printing section, is supplied through the lower through hole 159 and mixed with the mixed ink 105.

According to the printing machine of the second embodiment, the excess ink is dropped on the upper inclined surface 147 and returned to the sub tank 57c. Therefore, it is possible to reduce an impact force generated when the collected ink 103 is dropped from the ink collection passage 119 and thereby to avoid possibility that fine bubbles are generated in the mixed ink 105 in the sub tank 57c, as much as possible.

### Third Embodiment

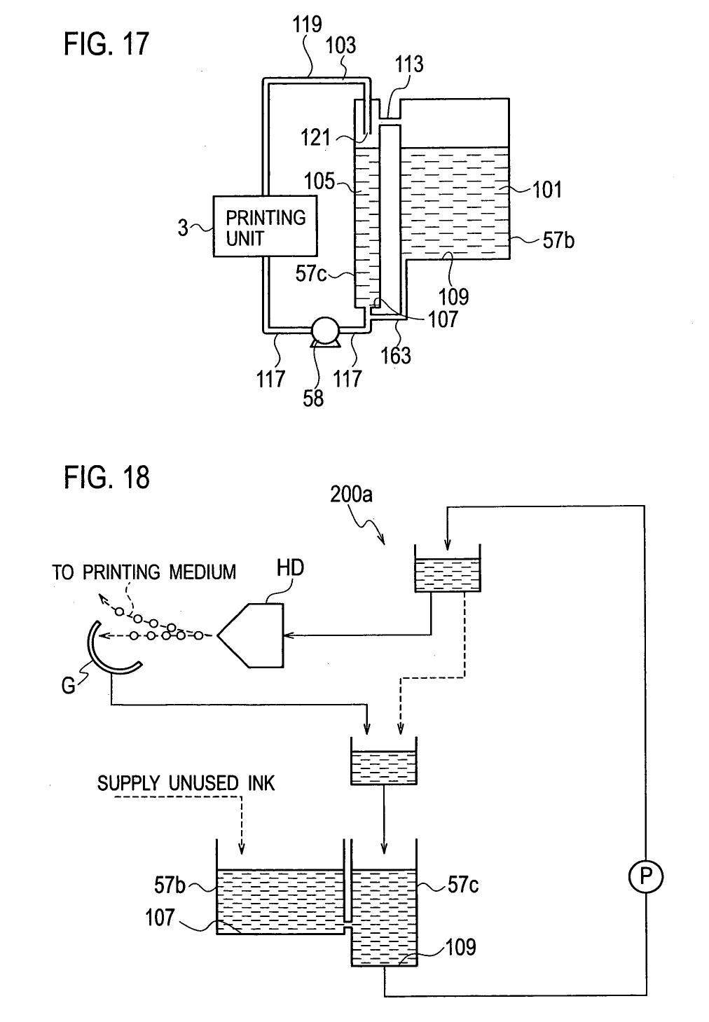

FIG. 17 is a view illustrating a schematic configuration of an ink tank and the like used in a stencil printing machine according to a third embodiment of the present invention, and corresponding to FIG. 11, for example.

The stencil printing machine according to the third embodiment differs from the stencil printing machine 100 illustrated in FIG. 11 in that the ink is supplied from a different portion of the main tank 57b. However, the other portions are configured in approximately the same manner as those of the stencil printing machine 100 according to the first embodiment, and therefore almost the same effect as in the first embodiment are exhibited. It should be noted that the portion to which the ink is supplied from the main tank 57b may be changed in the configurations illustrated in FIGS. 12 to 16, similar to FIG. 17.

The stencil printing machine according to the third embodiment printer according to the third embodiment includes: a printing section which transfers ink to a printing medium, the main tank 57b which stores unused ink; the sub tank 57c having a bottom surface 107 thereof located lower than the bottom surface 109 of the main tank 57b; an ink supply unit which supplies the ink stored in the sub tank 57c to the printing section; an ink collection unit which collects the excess ink 103 remaining in the printing unit without being used for transfer, from among the ink supplied to the printing section by the ink supply unit, and which returns the excess ink 103 to the sub tank 57c; and an ink supply passage 163 which supplies the unused ink 101 from the main tank 57b to the ink supply passage 117 of the ink supply unit by the action of gravity.

In addition, the supply of the unused ink 101 to the ink supply passage 117 from the main tank 57b is made mainly by the action of gravity. However, the ink pump 58 is provided, and therefore the supply of the unused ink 101 to the ink passage 117 from the main tank 57b is promoted by the ink pump 58.

Moreover, the configuration illustrated in FIG. 17 is one in which the unused ink 101 is not supplied directly to the sub tank 57c but supplied to the ink supply passage 117 of the ink supply unit 54 in the configuration illustrated in FIG. 11.

In the above described embodiments, the ink tank 57 is provided in the interior of the drum 26. However, the ink tank 57 may be provided outside of the drum 26, and further provided outside of the housing constituting the stencil printing machine 100.

Furthermore, although the above described embodiments have been explained using the stencil printing machine as an example, the ink tank 57 and the like according to the above described embodiments may be applied to an ink-circulation type printer using an inkjet head (see FIGS. 18 to 20).

Namely, as illustrated in FIG. 18, the present invention may be applied to a continuous type printer (see, for example, Japanese Unexamined Patent Application Publication No. Hei 2-196663). A printing machine 200a illustrated in FIG. 18 includes the main tank 57b, the sub tank 57c, an inkjet head HD, and a gutter G.

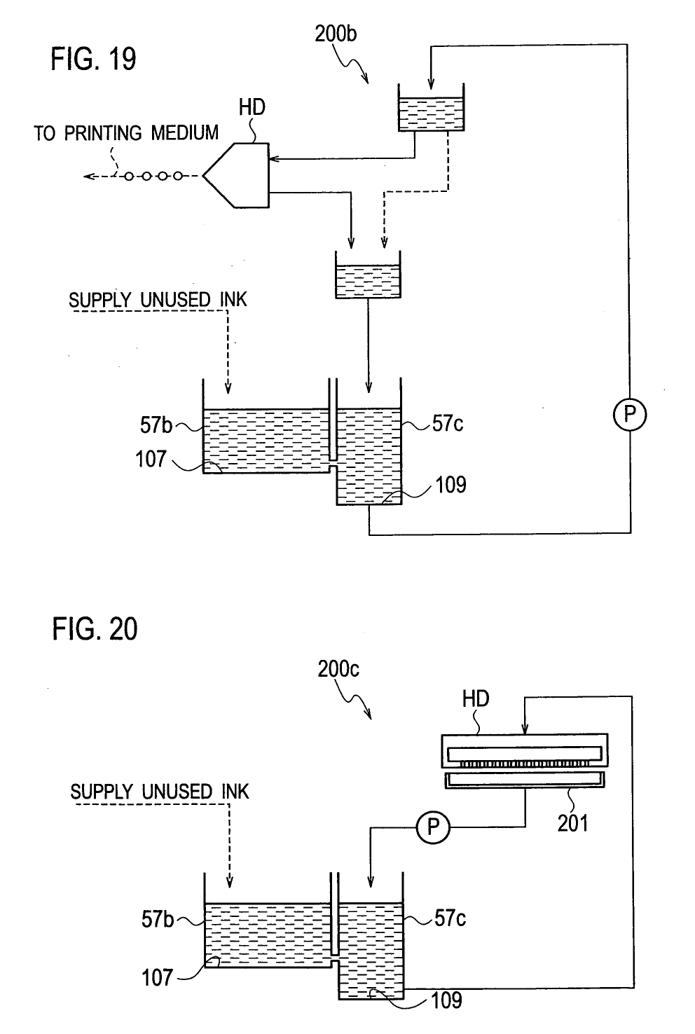

Moreover, as illustrated in FIG. 19, the present invention may be applied to a printing machine using a drop-on-demand method of a circulation type (see, for example, Japanese Patent Application Publication No. 2005-199579). A printing machine 200b illustrated in FIG. 19 includes the main tank 57b, the sub tank 57c and an inkjet head HD.

Furthermore, as illustrated in FIG. 20, the present invention may be applied to a printing machine using a drop-on-demand method of a waste ink collection type (see, for example, Japanese Patent Application Publication No. 2007-272144). A printing machine 200c illustrated in FIG. 20 includes the main tank 57b, the sub tank 57c, an inkjet head HD, and a purge unit 201. It should be noted that arrows in each of FIGS. 18 to 20 schematically illustrate ink flow.

The printer according to the embodiments of the present invention has been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiment of the present invention are only a list of optimum effects achieved by the present invention. Hence, the effects of the present invention are not limited to those described in the embodiment of the present invention.

What is claimed is:

1. A printer comprising:
a printing unit configured to transfer ink to a printing medium;
a main tank configured to store unused ink;
a sub tank having a bottom surface located lower than a bottom surface of the main tank and configured to receive supply of the unused ink from the main tank;
an ink supply unit configured to supply ink stored in the sub tank to the printing unit; and
an ink collection unit configured to collect excess ink from the ink supplied to the printing unit by the ink supply unit and to return the excess ink to the sub tank, the excess ink being ink remaining in the printing unit without being transferred to the printing medium by the printing unit.

2. The printer according to claim 1, wherein
the sub tank includes an upper side portion and a lower side portion, and
a cross-sectional area of the upper side portion taken along a horizontal plane is smaller than a cross-sectional area of the lower side portion taken along a horizontal plane.

3. The printer according to claim 1, wherein
the sub tank is divided into a plurality of portions at a place where the excess ink is returned to the sub tank by the ink collection unit, and
the sub tank is configured to use one of the divided portions to receive the excess ink returned by the ink collection unit.

4. The printer according to claim 1, wherein
the sub tank includes an upper sub tank and a lower sub tank connected to each other through a throttle,
the upper sub tank is configured to receive the ink supplied from the main tank,
the ink collection unit is configured to return the excess ink to the upper sub tank, and
the ink supply unit is configured to supply the ink stored in the lower sub tank to the printing unit.

5. The printer according to claim 4, wherein a cross-sectional area of the upper sub tank taken along a horizontal plane is smaller than a cross-sectional area of the lower sub tank taken along a horizontal plane.

6. The printer according to claim 4, wherein
the upper sub tank is divided into a plurality of portions at a place where the excess ink is returned to the upper sub tank by the ink collection unit, and
the upper sub tank is configured to use one of the divided portions to receive the excess ink returned by the ink collection unit.

7. The printer according to claim 5, wherein
the upper sub tank is divided into a plurality of portions at a place where the excess ink is returned to the upper sub tank by the ink collection unit, and
the upper sub tank is configured to use one of the divided portions to receive the excess ink returned by the ink collection unit.

8. The printer according to claim 1, further comprising:
a collected ink receiver configured to receive excess ink returned from the printing unit by the ink collection unit, wherein
the sub tank is configured to receive the excess ink from the collected ink receiver through an ink passage.

9. The printer according to claim 1, wherein the printing unit includes an inkjet head.

10. A printer comprising:
a printing unit configured to transfer ink to a printing medium;
a main tank configured to store unused ink;
a sub tank having a bottom surface located lower than a bottom surface of the main tank;
a first ink supply passage connected to the sub tank;
an ink supply unit configured to supply ink stored in the sub tank to the printing unit through the first ink supply passage;
an ink collection-unit configured to-collect excess ink from the ink supplied to the printing unit by the ink supply unit and to return the excess ink to the sub tank, the excess ink being ink remaining in the printing unit without being transferred to the printing medium by the printing unit; and
a second ink supply passage configured to supply the unused ink to the first ink supply passage from the main tank.

11. The printer according to claim 10, wherein
the sub tank includes an upper side portion and a lower side portion, and
a cross-sectional area of the upper side portion taken along a horizontal plane is smaller than a cross-sectional area of the lower side portion taken along a horizontal plane.

12. The printer according to claim 10, wherein
the sub tank is divided into a plurality of portions at a place where the excess ink is returned to the sub tank by the ink collection unit, and
the sub tank is configured to use one of the divided portions to receive the excess ink returned by the ink collection unit.

13. The printer according to claim 10, wherein
the sub tank includes an upper sub tank and a lower sub tank connected to each other through a throttle,
the upper sub tank is configured to receive the ink supplied from the main tank,
the ink collection unit is configured to return the excess ink to the upper sub tank, and
the ink supply unit is configured to supply the ink stored in the lower sub tank to the printing unit.

14. The printer according to claim 13, wherein a cross-sectional area of the upper sub tank taken along a horizontal plane is smaller than a cross-sectional area of the lower sub tank taken along a horizontal plane.

15. The printer according to claim 13, wherein
the upper sub tank is divided into a plurality of portions at a place where the excess ink is returned to the upper sub tank by the ink collection unit, and
the upper sub tank is configured to use one of the divided portions to receive the excess ink returned by the ink collection unit.

16. The printer according to claim 14, wherein
the upper sub tank is divided into a plurality of portions at a place where the excess ink is returned to the upper sub tank by the ink collection unit, and
the upper sub tank is configured to use one of the divided portions to receive the excess ink returned by the ink collection unit.

17. The printer according to claim 10, further comprising:
a collected ink receiver configured to receive excess ink returned from the printing unit by the ink collection unit, wherein
the sub tank is configured to receive the excess ink from the collected ink receiver through an ink passage.

18. The printer according to claim 10, wherein the printing unit includes an inkjet head.

19. A stencil printing machine comprising:
a rotatable drum including an outer peripheral wall being formed from an ink impermeable member, the outer peripheral wall having a surface for attachment of a stencil sheet;
an ink tank configured to store ink;
an ink supply unit including an ink supply section in the outer peripheral wall and configured to supply the ink guided from the ink tank to the surface of the outer peripheral wall by use of the ink supply section;
an ink collection unit including an ink collection section in the outer peripheral wall and configured to collect and return excess ink on the surface of the outer peripheral wall to the ink tank by use of the ink collection section; and
a pressure roller configured to press a fed printing medium onto the outer peripheral wall, wherein
the ink tank includes a main tank storing unused ink, and a sub tank storing both the excess ink collected by the ink collection unit and the unused ink stored in the main tank,
the ink supply unit is configured to supply the ink in the sub tank before the unused ink in the main tank, and
a bottom surface of the sub tank is located lower than a bottom surface of the main tank.

20. A stencil printing machine comprising:
a drum rotatably supported by a supporting member and including an outer peripheral wall being formed from an ink impermeable member, and the outer peripheral wall having a surface for attachment of a stencil sheet;
an ink tank configuration member provided integrally with the supporting member inside the drum;
a main tank having a space formed in an internal space of the ink tank configuration member, the space surrounded by a partition wall, a bottom configuration member and the ink tank configuration member, the partition wall dividing an internal space of the ink tank configuration member into parts, the bottom configuration member being provided integrally with the ink tank configuration member and the partition wall, a first end of the bottom configuration member at a side of the partition wall being disposed below the supporting member in a first one of the parts of the internal space divided by the partition wall and being located lower than a second end of the bottom configuration member at an opposite side of the first end;
a sub tank having an annular space surrounded by the partition wall, the ink tank configuration member, and an inner side member, the inner side member being provided in a second part of the internal space of the ink tank configuration member divided by the partition wall, being disposed at a middle position in a height direction of the second part, and including an upper inclined surface on an upper side of the inner side member and a lower inclined surface on a lower side of the inner side member,
wherein the partition has
a lower through hole formed at approximately the same height as a bottom surface of the main tank and connecting the space of the main tank and the space of the sub tank by penetrating the partition wall, and
an upper through hole formed in an upper side of both the sub tank and the main tank and connecting the space of the main tank and the space of the sub tank by penetrating the partition wall;
an ink supply unit including an ink supply section in the outer peripheral wall and configured to supply ink guided from a lower end of the sub tank to the surface of the outer peripheral wall by use of the ink supply section;
an ink collection unit including an ink collection section in the outer peripheral wall and configured to collect excess ink on the surface of the outer peripheral wall by use of the ink collection section, to drop the collected ink onto an upper inclined surface and thereby to return the collected ink to the sub tank; and
a pressure roller configured to press a fed printing medium onto the outer peripheral.
